(19) United States
(12) Patent Application Publication
(10) Pub. No.: US 2003/0177020 A1
(43) Pub. Date: Sep. 18, 2003

(54) Method and apparatus for realizing sharing of taxi, and computer product

(75) Inventor: Akiyo Okamura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/274,999

(22) Filed: Oct. 22, 2002

(30) Foreign Application Priority Data
Mar. 14, 2002 (JP) 2002-070717

(51) Int. Cl. G06F 17/60

(52) U.S. Cl. 705/1

(57) ABSTRACT

All the users have a portable terminal with them for transmitting and receiving formation to or from a server. User A is already onboard a taxi and sends his/her willingness to accept a parson to share the taxi. Users who wish to share a taxi also send their willingness to share the taxi. The server selects some users from among these users based on the destinations and locations of these users and the taxi. The server informs the user A about the selected users and their personal information such as male/female, drunk/non-drunk ect. The user A finally decides a candidate person with whom he/she would like to share the taxi. The information that he/she has been selected is sent to the candidate. The taxi driver is informed to pick-up the candidate from his/her present location.

### BACKGROUND OF THE INVENTION

1) Field of the Invention

The present invention relates to a technology that makes it possible to efficiently share a taxi by a plurality of passengers who do no know each other.

2) Description of the Related Art

Conventionally, it has been difficult to take a taxi when there are many people waiting for a taxi during midnight after the last train has departed or on a rainy day. The passengers would usually want to restrict the taxi fare. The system of sharing a taxi among passengers who have the same destination is hence required.

There has been a difficulty for the onboard passengers and also for the waiting passengers to find people who want to share a taxi. The confirmation of the destination of the person who wants to share the taxi has been difficult. There is a risk of sharing the taxi with an unknown person even when a person is able to determine others who needs to share the taxi. Hence there is a difficulty in promoting the sharing of taxi.

### SUMMARY OF THE INVENTION

It is an object of the invention to provide a taxi sharing management method to execute a safe system for sharing a taxi, a taxi sharing management program, a recording medium onto which a computer can read the taxi sharing management program, a taxi sharing management apparatus, a taxi sharing approval apparatus, and a taxi riding request apparatus.

In order to achieve the object of the invention by solving the above problems, according to one aspect of the invention, there are provided a taxi sharing management method, a computer program (taxi sharing management program) that realizes the method according to the present invention on a computer, and a recording medium onto which the computer program according to the present invention can be stored. The taxi sharing management method according to this aspect is as follows. In arranging a sharing of a taxi for first customers who want to ride a taxi with a second customer who is already onboard the taxi, one or a plurality of sharing candidates are determined from among the first customers, based on information relating to the first customers that includes request that is input by each of the first customers, and information relating to a current position and information relating to a destination that have been input together with the request or that have been extracted based on the request, and information relating to a destination and sharing approval that have been input by the second customer. A consenting person is selected from among the first customers as the determined sharing candidates. Based on the information relating to the selected consenting person, sharing consent relating to whether the sharing is consented is input, in response to the information relating to the second customer that is input together with the sharing approval or the information relating to the sharing candidates or that has been extracted based on the sharing approval. Based on the input information relating to the sharing consent, at least one of the sharing consent from the first customer as the consenting person and the information relating to a current position of the first customer is transmitted to at least one of the second customer and a driver of the taxi which the second customer is already onboard.

According to another aspect of the invention, there are provided a taxi sharing management method, a computer program (taxi sharing management program) that realizes the method according to the present invention on a computer, and a recording medium onto which the computer program according to the present invention can be stored. The taxi sharing management method according to this aspect is as follows. In arranging a sharing of a taxi for first customers who want to ride a taxi with a second customer who is already onboard the taxi, request for requesting a ride on a taxi is received from the first customers. Information relating to a destination and sharing approval for approving a sharing of a taxi are received from the second customer. One or a plurality of sharing candidates are determined from among the first customers, based on the information relating to the first customers that includes the request that has been received from each of the first customers, and information relating to a current position and information relating to a destination that have been received together with the request or that have been extracted based on the request, and the information relating to a destination and the sharing approval that have been received from the second customer. The information relating to the first customers as the determined sharing candidates is transmitted to the second customer. Information relating to a consenting person selected by the second customer from among the information relating to the first customers as the transmitted sharing candidates is received. Based on the received information relating to the consenting person, information relating to the second customer that has been received together with the sharing approval or the information relating to the sharing candidates or that has been extracted based on the sharing approval is transmitted to the first customer as the consenting person. Information relating to the sharing consent of the first customer as the consenting person is received, in response to the transmitted information relating to the second customer. Based on the received information relating to the sharing consent, at least one of the sharing consent from the first customer as the consenting person and the information relating to a current position of the first customer is transmitted to at least one of the second customer and a driver of the taxi which the second customer is already onboard.

According to still another aspect of the invention, there is provided a taxi sharing approval apparatus that enables persons who want to take a taxi to share the taxi. This taxi sharing approval apparatus inputs information relating to a destination and sharing approval for approving a sharing of a taxi. The information relating to a destination and the sharing approval for approving a sharing of a taxi that have been input are transmitted to a predetermined server. The taxi sharing approval apparatus receives the information relating to one or a plurality of persons who want to take a taxi in response to the sharing approval, from the server. A display screen is controlled to display the received information relating to the persons who want to take a taxi. A consenting person is selected from the information relating to the persons who want to take a taxi that is displayed on the display screen. The information relating to the selected consenting person is transmitted to the server. Then, the taxi sharing approval apparatus receives from the server at least one of sharing consent from the user B as the consenting person and information relating to a current position of the user B as the consenting person.

According to aspect of the invention, there is provided a taxi riding request apparatus that is used by a person who wants to take a taxi. This taxi riding request apparatus inputs request for requesting a ride on a taxi. The input request is transmitted to a predetermined server. Information relating to a person who is already onboard a taxi to share the taxi is received in response to the request, from the server. A display screen is controlled to display the received information relating to the other person who shares the taxi. Sharing consent relating to whether the sharing of the taxi is to be consented is input in response to the information relating to the other person who shares the taxi that is displayed on the display screen. The input sharing consent is transmitted to the server.

According to the above aspects of the invention, sharing candidates are determined based on request from first customers who want to take a taxi and sharing approval from a second customer who is already onboard a taxi. The information relating to the sharing candidates (the first customers) is transmitted to the second customer. At the same time, the information relating to the second customer is also transmitted to the first customer who has been selected as a consenting person by the second customer based on the information relating to the sharing candidates (the first customers). The first customer decides whether to consent to the sharing of the taxi based on the information relating to the second customer. As explained above, it becomes easy to find the other person who is to share the taxi, and it becomes possible to know the other person who is to share the taxi. With this arrangement, it is possible to implement the sharing of the taxi based on mutual agreement.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is an explanatory diagram that shows the outline of an embodiment of the present invention,

FIG. 2 is a system configuration diagram of a taxi sharing management system that includes a taxi sharing management apparatus, a taxi sharing approval apparatus, and a taxi riding request apparatus relating to the embodiment of the present invention,

FIG. 3 is a block diagram that shows one example of a hardware configuration of a sharing management server 101 as a taxi sharing management apparatus,

FIG. 4 is a block diagram that shows one example of a hardware configuration of a terminal 102 as a taxi sharing approval apparatus,

FIG. 5 is a block diagram that shows one example of a hardware configuration of a portable terminal 103 as a taxi riding request apparatus,

FIG. 6 is a block diagram that shows the functional configuration of the sharing management server 101 as a taxi sharing management apparatus.

FIG. 7 is a block diagram that shows the functional configuration of the terminal 102 as a taxi sharing approval apparatus,

FIG. 8 is a block diagram that shows the functional configuration of the portable terminal 103 as a taxi riding request apparatus,

FIG. 9 is a flowchart that shows a mutual process of the sharing management server 101 as a taxi sharing management apparatus, the terminal 102 as a taxi sharing approval apparatus, and the portable terminal 103 as a taxi riding request apparatus,

FIG. 10 is a flowchart that shows a process of the sharing management server 101 as a taxi sharing management apparatus,

FIG. 11 is a flowchart that shows another process of the sharing management server 101 as a taxi sharing management apparatus,

FIG. 12 is a flowchart that shows a process of the terminal 102 as a taxi sharing approval apparatus (part one),

FIG. 13 is a flowchart that shows a process of the terminal 102 as a taxi sharing approval apparatus (part two),

FIG. 14 is a flowchart that shows a process of the terminal 102 as a taxi sharing approval apparatus (part three),

FIG. 15 is an explanatory diagram that shows an input screen of a starting place and a target place of the terminal 102 as a taxi sharing approval apparatus,

FIG. 16 is an explanatory diagram that shows an input screen of a starting place, a target place, and a soft keyboard of the terminal 102 as a taxi sharing approval apparatus,

FIG. 17 is an explanatory diagram that shows an input screen of a starting place and a target place of the terminal 102 as a taxi sharing approval apparatus,

FIG. 18 is an explanatory diagram that shows a route confirmation screen of the terminal 102 as a taxi sharing approval apparatus,

FIG. 19 is an explanatory diagram that shows a taxi sharing approval indication screen of the terminal 102 as a taxi sharing approval apparatus,

FIG. 20 is an explanatory diagram that shows a presentation information input screen of the terminal 102 as a taxi sharing approval apparatus,

FIG. 21 is an explanatory diagram that shows an electronic signature screen of the terminal 102 as a taxi sharing approval apparatus,

FIG. 22 is an explanatory diagram that shows an image authentication information input screen of the terminal 102 as a taxi sharing approval apparatus,

FIG. 23 is an explanatory diagram that shows an authentication information input screen of the terminal 102 as a taxi sharing approval apparatus,

FIG. 24 is an explanatory diagram that shows a taxi sharing condition information screen of the terminal 102 as a taxi sharing approval apparatus,

FIG. 25 is an explanatory diagram that shows a sharing candidate information input screen of the terminal 102 as a taxi sharing approval apparatus,

FIG. 26 is an explanatory diagram that shows a consenting person information screen and a sharing candidate information screen of the terminal 102 as a taxi sharing approval apparatus,

FIG. 27 is an explanatory diagram that shows a consenting person information screen of the terminal 102 as a taxi sharing approval apparatus,

FIG. 28 is an explanatory diagram that shows an enquiry screen of the terminal 102 as a taxi sharing approval apparatus,

FIG. 29 is an explanatory diagram that shows the sharing consent of the terminal 102 as a taxi sharing approval apparatus,

FIG. 30 is an explanatory diagram that shows a sharing consent of the terminal 102 as a taxi sharing approval apparatus,

FIG. 31 is an explanatory diagram that shows an route screen of the terminal 102 as a taxi sharing approval apparatus,

FIG. 32 is an explanatory diagram that shows an operation status screen of the terminal 102 as a taxi sharing approval apparatus,

FIG. 33 is a flowchart that shows a process of the portable terminal 103 as a taxi riding request apparatus (part one),

FIG. 34 is a flowchart that shows a process of the portable terminal 103 as a taxi riding request apparatus (part two),

FIG. 35 is an explanatory diagram that shows a request input screen of the portable terminal 103 as a taxi riding request apparatus,

FIG. 36 is an explanatory diagram that shows an electronic signature screen of the portable terminal 103 as a taxi riding request apparatus,

FIG. 37 is an explanatory diagram that shows an image authentication information input screen of the portable terminal 103 as a taxi riding request apparatus,

FIG. 38 is an explanatory diagram that shows an authentication information input screen of the portable terminal 103 as a taxi riding request apparatus,

FIG. 39 is an explanatory diagram that shows a condition input screen of the portable terminal 103 as a taxi riding request apparatus,

FIG. 40 is an explanatory diagram that shows a waiting screen of the portable terminal 103 as a taxi riding request apparatus,

FIG. 41 is an explanatory diagram that shows a user A information display screen of the portable terminal 103 as a taxi riding request apparatus, and

FIG. 42 is an explanatory diagram that shows a taxi sharing implementation display screen of the portable terminal 103 as a taxi riding request apparatus.

### DETAILED DESCRIPTIONS

An embodiment of a taxi sharing management method for arranging a sharing of a taxi among passengers, a taxi sharing management program, a taxi sharing management apparatus, a taxi sharing approval apparatus, and a taxi riding request apparatus relating to the present invention is explained in detail with reference to the accompanying drawings.

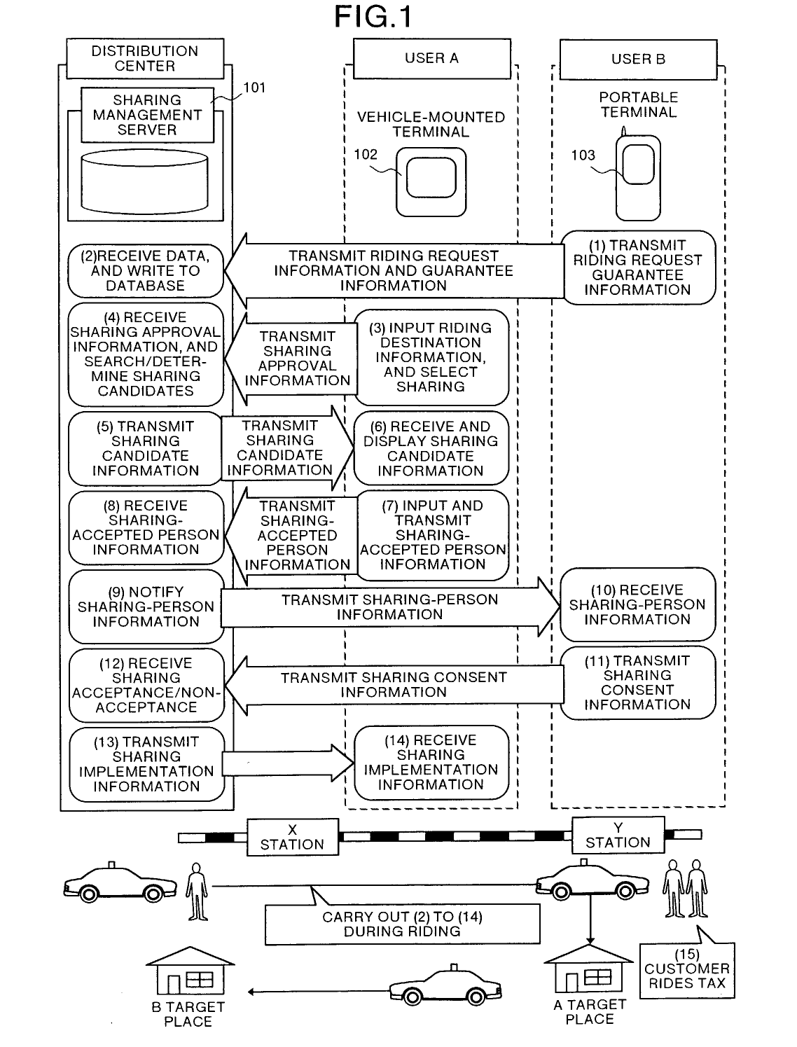

FIG. 1 is a diagram that explains the outline of the embodiment of the present invention. In FIG. 1, a user B is a person who wants to take a taxi. The user B transmits a request and guarantee information to a sharing management server 101 by using a portable terminal 103 (step 1). The sharing management server 101 is located at a distribution center. The sharing management server 101 receives the riding request and the guarantee information and writes the data into a predetermined database (step 2).

User A is a person who is already onboard a taxi. When the user A (consenting person) decides to share the taxi, the user A inputs a destination, and an approval to share the taxi in a terminal 102 that is mounted in the taxi. The approval of user A is transmitted to the sharing management server 101 by the terminal 102 (step 3). The sharing management server 101 collects information of the consenting person (step 4). The sharing management server 101 transmits information of the consenting person to the terminal 102 (step 5). The terminal 102 displays the received information on a display screen (step 6).

The terminal 102 receives details of the consenting person and transmits the information to the sharing management server 101 (step 7). The sharing management server 101 receives the information relating to the consenting person (step 8). The sharing management server 101 notifies the approval of user A, the consenting person, to the user B (step 9). The portable terminal 103 receives the information relating to the consenting person from the sharing management server 101, and analyzes whether the user B will agree to share the taxi with the consenting person (step 10). When the user B agrees to share the taxi with the consenting person, the user B inputs the information to the portable terminal 103. The information input by the user B is then transmitted to the sharing management server 101 (step 11). The sharing management server 101 receives the acceptance or non acceptance of the user B from the portable terminal 103 (step 12). The sharing management server 101 transmits the information of the user B to the terminal 102 that is accessed by user A (step 13). The terminal 102 receives the information from the sharing management server 101 (step 14). The sharing information may also be transmitted to the user B for the sake of confirmation. The steps 2 to 14 is carried out when the user A is onboard the taxi. The taxi proceeds from a station X to pick up the user B at station Y (step 15). The taxi then heads for the destinations A and B depending on the requirement of the user A and B.

The configuration of a taxi sharing management system as the first embodiment of the present invention is explained next. The taxi sharing management system includes a taxi sharing management apparatus, a taxi sharing approval apparatus, and a taxi riding request apparatus.

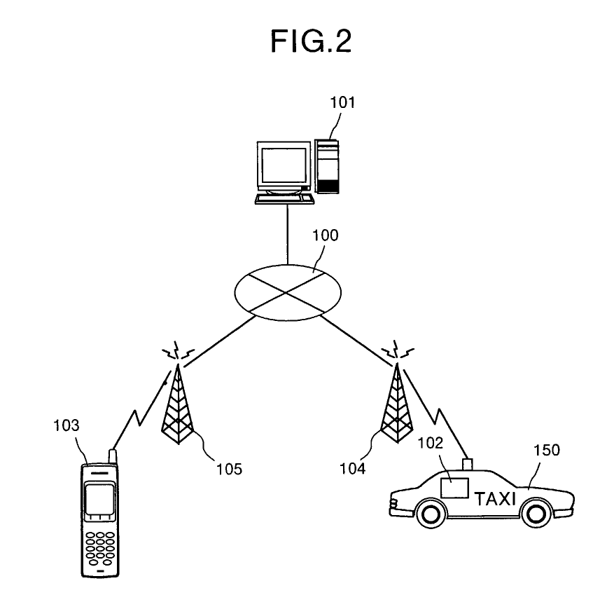

FIG. 2 shows the taxi sharing management system. In FIG. 2, the taxi sharing management system includes the internet, the sharing management server 101, the terminal 102, the portable terminal 103, a relay station 104, and a relay station 105. The relay station 104 carries out radio communication with the terminal 102 that is mounted on a taxi 150. The relay station 105 carries out radio communication with the portable terminal 103. The relay stations may also be defined as radio stations. The relay stations 105 and 104 are connected to a common network 100. The sharing management server 101 is also connected to the network 100. The terminal 102 and the portable terminal 103 are hence connected to each other through the sharing management server 101 and the relay stations 104 and 105 by the network 100.

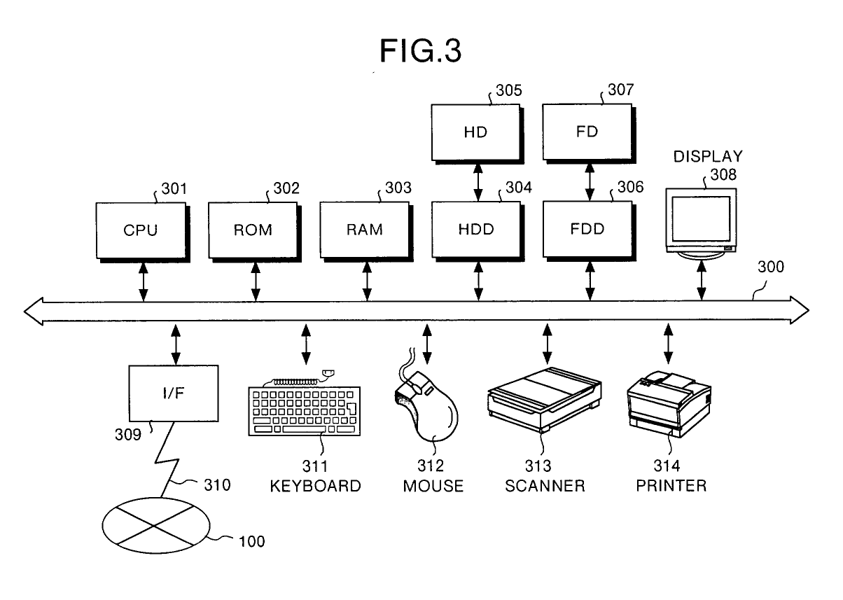

The sharing management server 101 has a hardware configuration shown in FIG. 3. The sharing management server 101 is recorded with a program for receiving information from the terminal 102 and the portable terminal 103, a program for determining the candidates who want to share the taxi, and a program for the approval or disapproval of the candidates. The sharing management server 101 also has a database relating to the taxi 150, a database relating to customer information, and a database relating to map information.

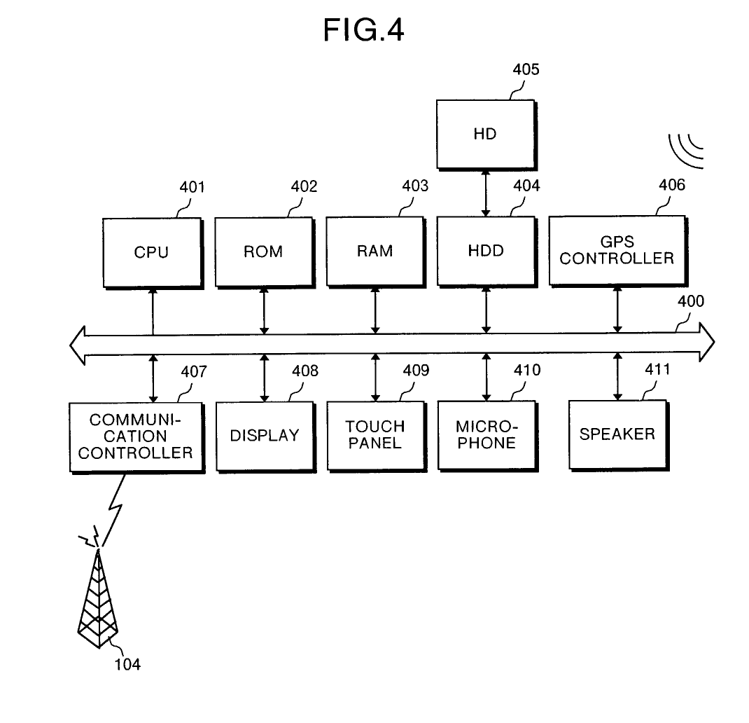

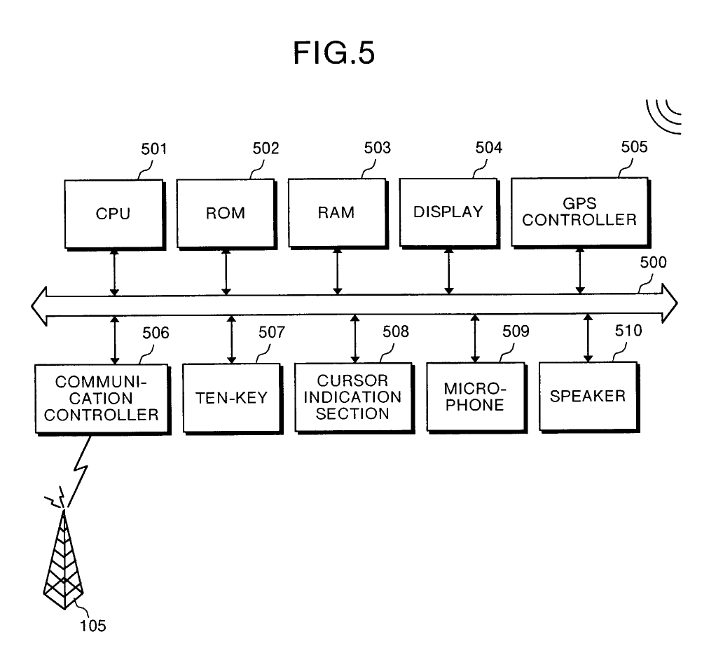

The terminal 102 has a hardware configuration shown in FIG. 4. The terminal 102 is installed at the backside of the front seat in the taxi 150. The terminal 102 can be operated by the passenger seated in the back seat. The terminal 102 may also be installed such that it can be operated by the driver. The terminal 102 may be a mobile phone owned by the user A. In this case, the mobile phone communicates with an information processing device that is mounted in the taxi 150 based on radio communication standard like Blue Tooth. Bluetooth is a technology that enables the data synchronization between disparate devices in the short-distance range. The mobile phone used as the terminal 102 has a hardware configuration shown in FIG. 5. The portable terminal 103 also has a hardware configuration as shown in FIG. 5. The portable terminal 103 has an inbuilt functionality of radio communication. The portable terminal 103 could be a mobile phone, a personal digital assistant (PDA), or a notebook PC.

The configuration of the sharing management server 101 as one of the taxi sharing management apparatuses relating to the embodiment of the present invention is explained next. In FIG. 3, the sharing management server 101 consists of a central processing unit CPU 301, a read only memory ROM 302, a random access memory RAM 303, a hard disk drive HDD 304, a hard disk HD 305, a flexible disk drive FDD 306, a flexible disk FD 307, a display 308, an interface 309, a keyboard 311, a mouse 312, a scanner 313, and a printer 314. The flexible disk FD 307 is an example of a detachable recording medium. The components of the sharing management server 101 are connected to each other through a bus 300.

The CPU 301 controls the operations of the sharing management server 101. The ROM 302 stores the boot program. The RAM 303 is used as the work area for the CPU 301. The HDD 304 controls the read/write of data to the HD 305 based on the instructions given by the CPU 301. The HD 305 stores the written data based on the operation of the HDD 304. The FDD 306 controls the reading to the FD 307 and writing from the FD 307 based on the instructions given by the CPU 301. The FD 307 stores the written data based on the operation of the FDD 306 and the stored data is read to the information processing device. A CD-ROM with read and write abilities, a magneto optical drive MO, a digital versatile disk DVD, and a memory card could be provided in addition to the FD 307. The display 308 displays a cursor, icons, a toolbox, documents, images, and functional information. The display 308 may be of the type of a cathode ray tube CRT, a TFT liquid crystal display, or a plasma display.

The interface 309 is connected to the network 100 like LAN or internet through a communication line 310. The interface 309 is further connected to another server and information processing device through the network 100. The interface 309 interfaces between the network 100 and the internal components of the server. The interface 309 also controls the input/output of data from the other server and the information terminal device. For example, the interface 309 may be a modem.

The keyboard 311 has keys for inputting characters, numbers, and instructions and is used to input data. The keyboard 311 may have a touch-panel input pad, or a ten-key pad. The mouse 312 is used to move the cursor, select a range, move windows, and change sizes of the windows. A track ball, a joystick, a cross-key, or a jog dial may also be used as a pointing device similar to the mouse 312. The scanner 313 is used to optically read images and fetch image data into the information processing device. The printer 314 is used to print data that may be in the form of image or document. The printer 314 may be a laser printer or an ink-jet printer.

The hardware configuration of the terminal 102 as a taxi sharing approval apparatus relating to the embodiment of the present invention is explained next. As shown in FIG. 4, the terminal 102 consists of a CPU 401, a ROM 402, a RAM 403, an HDD 404, an HD 405, a global positioning system controller 406 (GPS controller 406), a communication controller 407, a display 408, a touch panel 409, a microphone 410, and a speaker 411. The components of the terminal 102 are connected to each other through a bus 400.

The CPU 401 controls the operation of the terminal 102. The ROM 402 stores a boot program. The RAM 403 is used as a work area for the CPU 401. The HDD 404 controls the read/write of data to the HD 405 based on the instructions of the CPU 401. The HD 405 stores the data that is written by the operation of the HDD 404.

The GPS controller 406 receives radio wave from a global positioning system satellite (GPS satellite) that is not shown in the diagram. The GPS controller 406 obtains the geometric position of the terminal 102 relative to the GPS satellite. The GPS controller 406 has the ablility to measure any given point on the surface of earth. The frequencies generated from the fundamental satellite clock frequency is f=10.23 MHz. The signals generated from a standard frequency of 10.23 MHz are L1 at 1575.42 MHz and L2 at 1227.60 MHz are termed as carriers. The GPS controller 406 uses the L1 frequency of 1575.42 MHz. Since the carriers cannot be used easily for instantaneous positioning purposes, a binary C/A (coarse acquisition) code and a navigation message are modulated onto the carriers. The C/A code is a pseudo random (PN) binary code consisting of 1,023 elements, or chips that repeats itself every millisecond. The rate at which each chip is modulated onto the carrier is 1.023 Mbps. The chip length is approximately 300 m and due to the code length, the complete C/A code pattern repeats itself every 300 km between the receiver and the satellite. The GPS satellite transmits the navigation message to the receiver, the navigation message containing the satellite orbital and clock information. The navigation message has a bit rate of 40 bps and a code length of 300 bits=6 s for a sub frame, and 1400 bits=30 s for a main frame. The basic message unit is one frame which is 1500 bits long. One main frame consists of five subframes, one subframe consists of 10 words, and 1 word consists of 3 bits. Finally, one master frame includes 25 pages of subframes 4 and 5 that is equal to 37,500 bits taking 12.5 minutes to transmit.

The communication controller 407 controls the transmission and reception of radio waves to and from the radio base station 104. The communication controller 407 is connected to the sharing management server 101 through the network 100 and controls the input and output of data to and from the sharing management server 101. The communication controller 407 also interfaces with the components of the terminal 102 through the network 100.

The display 408 displays a cursor, icons, a toolbox, data, images, and functional information. The display 408 may be of the TFT liquid crystal display type. The touch panel 409 that is provided on the display 408 is used to input characters, numbers, and instructions by the icons and buttons. The microphone 410 inputs the voice information by converting voice into an electric signal. The microphone 410 is used in place of the touch panel 409 or used along with the touch panel 409 in order to input information to the terminal 102. The speaker 411 is used in place of the display 408 or is used along with the display 408, to output information through the voice.

The hardware configuration of the portable terminal 103 as a taxi riding request apparatus relating to the embodiment of the present invention is explained next. FIG. 5 assumes that the portable terminal 103 is a mobile phone. The portable terminal 103 consists of a CPU 501, a ROM 502, a RAM 503, a display 504, a GPS controller 505, a communication controller 506, a ten-key 507, a cursor instruction section 508, a microphone 509, and a speaker 510. The components of the portable terminal 103 are connected to each other through a bus 500.

The CPU 501 controls the operation of the portable terminal 103. The ROM 502 stores a boot program. The RAM 503 is used as a work area for the CPU 501. The display 504 displays a cursor, icons, a toolbox, data, images, and functional information. The display 504 may be of the TFT liquid-crystal display type.

The GPS controller 505 is configured in the same manner as the GPS controller 406 shown in FIG. 4. The communication controller 506 is also configured in the same manner as the communication controller 407 shown in FIG. 4. Therefore, the explanation of the GPS controller 505 and the communication controller 506 is omitted.

The ten-key 507 has keys for inputting characters, numbers, instructions, and data. The cursor instruction section 508 is used to move the cursor and select a range on the screen. Across-key or a jog dial is used as a pointing device. The microphone 509 is used to input the voice by converting voice into an electric signal. The speaker 510 outputs the voice. The microphone 509 and the speaker 510 performs the function of a telephone.

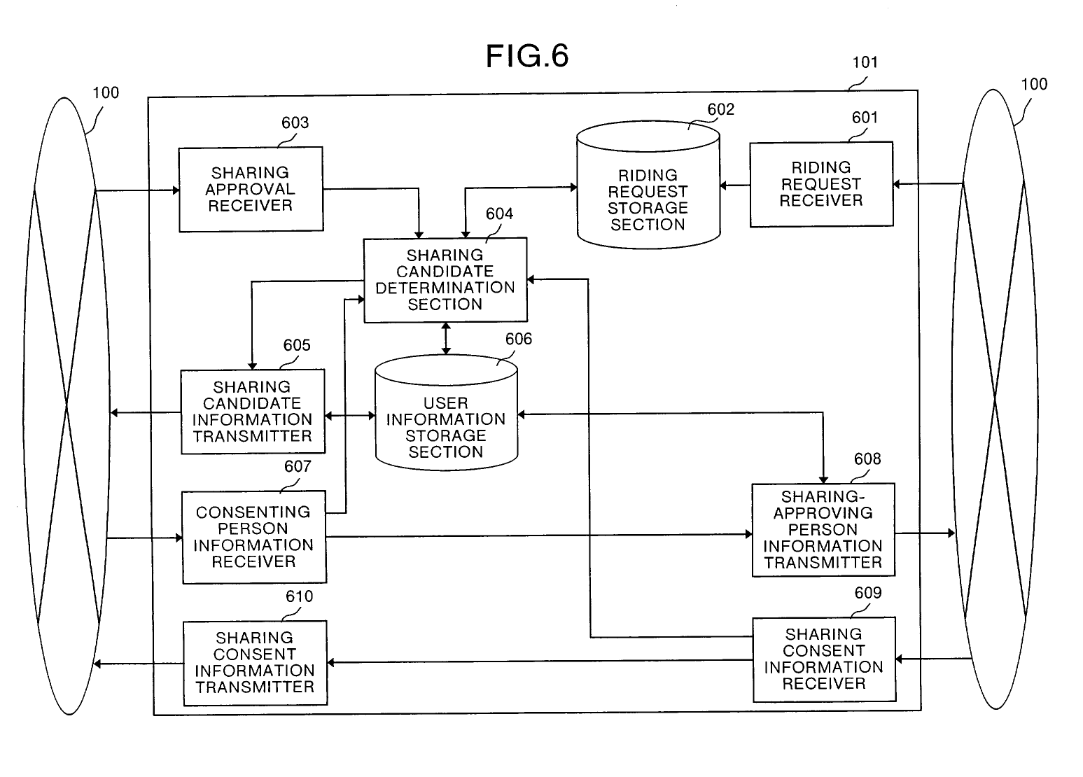

FIG. 6 is a block diagram that shows the functional configuration of the sharing management server 101 relating to the embodiment of the present invention. As shown in FIG. 6, the sharing management server 101 includes a receiver 601 (riding request receiver), a storage section 602 (riding request storage section), a receiver 603 (sharing approval receiver), a determination section 604 (sharing candidate determination section), a transmitter 605 (sharing candidate information transmitter), a storage section 606 (user information storage section), a receiver 607 (consenting person information receiver), a transmitter 608 (sharing approving person information transmitter), a receiver 609 (sharing consent information receiver), and a transmitter 610 (sharing consent information transmitter) The receiver 601 receives information of the request to share the taxi from the portable terminal 103 that is used by user B. The section 602 stores the information regarding the request of user B to share the taxi. The receiver 603 receives the approval to share the taxi from the terminal 102 used by user A. The section 604 determines the candidates who would like to share the taxi. The transmitter 605 transmits the information of the user B who would like to share the taxi to the terminal 102 of user A. The receiver 607 receives the information regarding the consenting person. The transmitter 608 transmits the information of the person who approves to share the taxi. The receiver 609 receives the information of the person who consents to share the taxi. The transmitter 610 transmits the information regarding the consent of the person who would share the taxi.

The receiver 601 receives the request from the portable terminal 103. The request includes the required arrival time of the taxi, the permissible time that the user B can wait for the taxi, the gender, whether the user B prefers smoking or non-smoking, and whether the user B consumed alcohol. The request may also include information that guarantees the social standing of the user B. To be more specific, the request includes authentication information based on the input of a password, an electronic signature, an image, and a keyword that is registered within a group, in advance. Therefore, it is possible to avoid any false or pretentious request to share the taxi by authentication of the identity of user B.

The receiver 601 is realized with the interface 309 shown in FIG. 3, for example. The storage section 602 stores the information received by the receiver 601. The storage section 602 is the RAM 303, HD 305, HDD 304, FD 307, or the FDD 306 shown in FIG. 3, for example. The receiver 603 receives the information relating to the destination and the approval of the user A to share the taxi from the terminal 102. The current position of the taxi is continuously monitored. When the current position information is not known, the receiver 603 is adjusted to receive the current position of the taxi.

The determination section 604 receives the information from the storage section 602 and the receiver 603 and determines the candidates who would like to share the taxi. The determination section 604 operates based on the request of user B to share the taxi (information 1), the current position and destination of user B (information 2), the approval or disapproval of user A to share the taxi (information 3), and the current position and destination of user A (information 4). The determination section 604 is executed by the CPU 301 shown in FIG. 3. The CPU 301 executes the programs stored in ROM 302, RAM 303, HD 305, and FD 307 also shown in FIG. 3.

The user B sends the details of information 1 and information 2 to the receiver 601. The current position is measured by the GPS controller 505 shown in FIG. 5, for example. The information 2 and information 4 is collected and stored in the storage section 606 for later reference. The usage of the information stored in advance in the storage section 606, is based on the information 1.

The receiver 603 receives the information 4 and the information 2 from the user A. The receiver 603 may also receive the information regarding the destination or the current position of user B stored in the storage section 606. The determination section 604 determines the user B who would like to share the taxi. The transmitter 605 receives the information relating to user B from the determination section 604. The transmitter 605 transmits the information relating to user B again to the terminal 102. The information relating to the user B is received along with the request of user B, or may be stored in advance in the storage section 606.

The storage section 606 stores the authentication information of the user A and user B. The authentication information includes the address, name, age, occupation, and e-mail address. The user information can also be retrieved when the user membership has been registered already. The storage section 606 performs the operation based on RAM 303, HD 305, HDD 304, FD 307, and FDD 306 as shown in FIG. 3, for example.

The receiver 607 receives the consent of the user A from the terminal 102. The user A makes the judgment of whether to share the taxi based on the information relating to user B, which is transmitted from the transmitter 605. The information transmitted from the transmitter 605 relates to the identification of a particular user B from many who would like to share the taxi. When there is no user B wanting to share the taxi, the information that there is no consenting person is displayed. When there is only one user B wanting to share the taxi, the information as to whether the user B has to be selected is displayed.

The transmitter 608 transmits the information of the consent of the user A to share the taxi from the receiver 607 to the portable terminal 103. The information transmitted by the transmitter 608 is related to the approval and the details of the consenting persons. The information related to the user A may also be extracted from the storage section 606. The receiver 609 receives the final consent of user B to share the taxi with the user A based on the information provided by the transmitter 608. The consent of user B implies that the user B has confirmed the details of user A.

The transmitter 610 receives the consent of the user B and transfers the consent to the transmitter 610. The transmitter 610 transfers the current position of the user B to the terminal 102 or the information terminal device of the driver of the taxi 150 or both. If the transmitter 605 has already transmitted the current position of the user B, it is not necessary to transmit the same information again. When the information related to the current position of the user B has been transmitted, it can be judged that the user B has consented to share the taxi. Therefore, it is not necessary to be more specific send the consent of the user B as the current position is already available indicating the consent of the user B.

The receivers 601, 603, 607, and 609 and the transmitters 605, 608, and 610 capture and display the data through the interface 309 shown in FIG. 3. The CPU 301 controls the operation of the receiving and transmitting devices by executing the programs stored in ROM 302, RAM 303, HD 305, and FD 307 shown in FIG. 3.

When the determined user B does not meet the prerequisites of the user A, the determination section 604 determines another user B. To be more specific, when the information received by the receiver 607 is that there is no consenting person, the determination section 604 selects a different user B to share the taxi. The transmitter 605 transmits the information relating to the determined user B to the terminal 102. When there is no appropriate user B meeting the requirements of user A, the message that there is no sharing candidate is displayed in the terminal 102.

The determination section 604 determines a sharing candidate different from the determined sharing candidate, based on the consent to share the taxi received by the receiver 609. To be more specific, when the receiver 609 receives the information that sharing of the taxi is not consented, the determination section 604 selects a taxi user B who is different from the determined sharing candidate. When there is no corresponding candidate, the message that there is no sharing candidate is displayed on the terminal 102. The transmitter 605 transmits the information relating to the determined sharing candidate to the terminal 102.

The process of determining a different sharing candidate is carried out repeatedly until a consenting person is determined. However, as the taxi 150 is moving towards the destination of the user A, it is necessary to change the sharing candidate each time. When a consenting person has not been determined after a lapse of a predetermined period of time, or when a consenting person has not been determined even after repeatedly carrying out the above process by a predetermined number of times, the process is stopped.

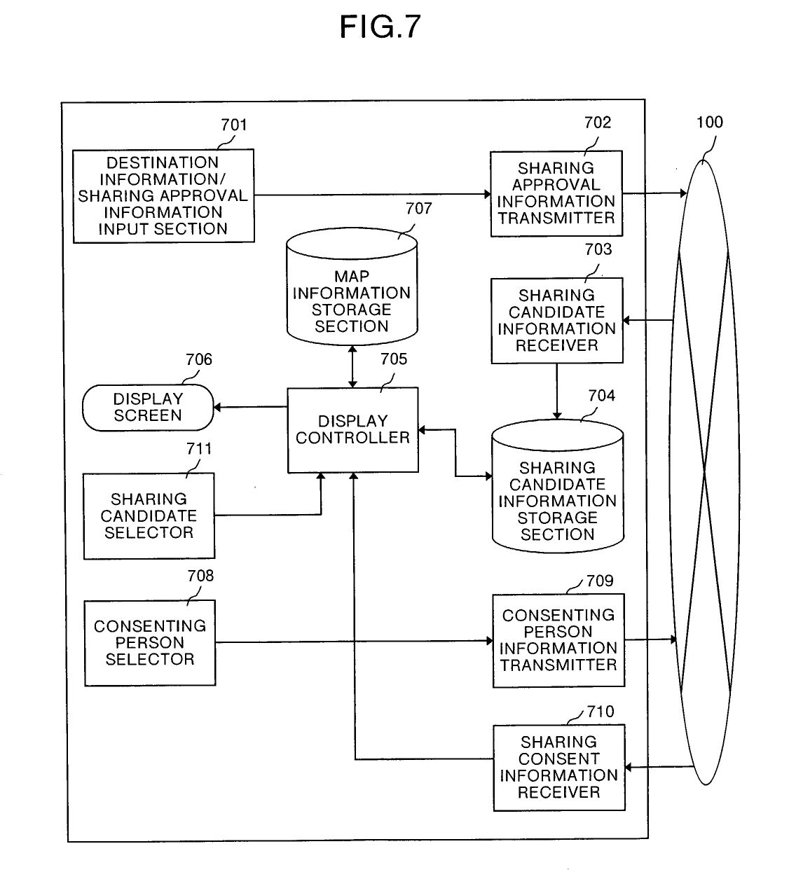

The functional configuration of the terminal 102 as a taxi sharing approval apparatus relating to the embodiment of the present invention is explained next. FIG. 7 is a block diagram that shows the functional configuration of the taxi sharing approval apparatus, the terminal 102 relating to the embodiment of the present invention. As shown in FIG. 7, the terminal 102 includes an input section 701 (destination information/sharing approval input section), a transmitter 702 (sharing approval transmitter), a receiver 703 (sharing candidate information receiver), a storage section 704 (sharing candidate information storage section), a display controller 705, a display screen 706, a map information storage section 707, a consenting person selector 708, a transmitter 709 (consenting person information transmitter), a receiver 710 (sharing consent receiver), and a sharing candidate selector 711. The input section 701 allows the input of the destination and the approval of the user A. The transmitter 702 transmits the approval of the user A to share the taxi. The receiver 703 receives the information of the sharing candidate. The storage section 704 stores the information of the sharing candidate. The transmitter 709 transmits the information of the consenting user A. The receiver 710 receives the consent of the user B to share the taxi.

The section 701 inputs information relating to the current position, destination and approval to share the taxi. The input section 701 is, for example, the touch panel 409 shown in FIG. 4. The information relating to the current position may be input directly, or may be obtained from the GPS controller 406 shown in FIG. 4. The transmitter 702 transmits the information relating to the destination and the sharing approval from the input section 701 to the sharing management server 101. In this arrangement, it is possible to complete the registration of the approval of user A. The receiver 703 receives information relating to one or a plurality of users B in response to the approval transmitted by the transmitter 702 from the sharing management server 101. The storage section 704 stores the information relating to the user B received by the receiver 703. The storage section 704 realizes its function with the ROM 402, the RAM 403, the HD 405, and the HD 404.

The display controller 705 controls the display screen 706 to display the information relating to the request received by the receiver 703 and stored by the storage section 704. The CPU 401 controls the operation of the display controller 705. The CPU 401 realizes its function by executing the programs stored in the ROM 402, the RAM 403, and the HD 405 shown in FIG. 4 with the CPU 401. To be more specific, the display screen 706 realizes its function with the display 408 shown in FIG. 4.

The map information storage section 707 stores the map information. The display controller 705 controls the display screen 706 to display the map extracted from the map information storage section 707. The display controller 705 displays a route to the destination on the map, and marks the current position and destination of the user B on the map. The map information storage section 707 realizes its function with the ROM 402, the RAM 403, the HD 405, and the HDD 404 or the like.

The consenting person selector 708 selects a consenting person from the information of relating to the user B displayed on the display screen 706. The consenting person selector 708 realizes its function by the touch panel 409 or the like. The transmitter 709 transmits the information relating to the consenting person selected by the consenting person selector 708, to the sharing management server 101. With this arrangement, the selection of the consenting person is possible.

The receiver 710 receives the consent and the current position of the user B from the sharing management server 101. In other words, when the user B information has not yet been received, the receiver 710 receives the consent and the user B information. When the user B information has already been received, the receiver 710 receives only the consent of user B. It is also possible to receive the user B information instead of the consent from user B to share the taxi. The user B information can be regarded as the consent from user B to share the taxi. In this case, only the user B information may be received.

The sharing candidate selector 711 selects a user B by indicating at least one of the current positions and the destination of the user B marked on the display screen 706. At this time, the display controller 705 controls the display screen 706 to display the information relating to the sharing candidate selected by the sharing candidate selector 711. To be more specific, the sharing candidate selector 711 realizes its function with the touch panel 409 or the like shown in FIG. 4. The receivers 703 and 710 and the transmitters 702 and 709 realize their functions with the communication controller 407 shown in FIG. 4. To be more specific, the CPU 401 controls the operation by executing the programs stored in the ROM 402, the RAM 403, and the HD 405 shown in FIG. 4

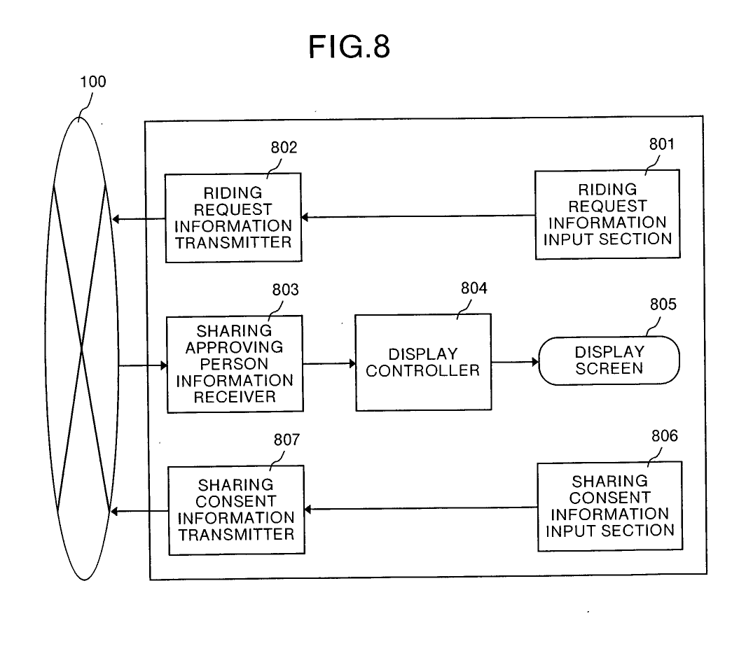

FIG. 8 is a block diagram that shows the functional configuration of the portable terminal 103 relating to the embodiment of the present invention. As shown in FIG. 8, the portable terminal 103 includes an input section 801 (riding request input section), a transmitter 802 (request transmitter), a receiver 803 (sharing approving person information receiver), a display controller 804, a display screen 805, an input section 806 (sharing consent input section), and a transmitter 807 (sharing consent transmitter). The user B inputs the request to share the taxi using the input section 801. The transmitter 802 transmits the input information of the request to share the taxi from the input section 801 to the sharing management server 101. The receiver 803 receives the approval of user A to share the taxi. The input section 806 inputs the consent of user B to share the taxi. The transmitter 807 transmits the consent of the user B to share the taxi from the input section 806 to the sharing management server 101.

The user B inputs the request to share the taxi 150 using the input section 801. The request input section 801 realizes its function with the ten-key 507 or the cursor instruction section 508, for example. The transmitter 802 transmits the request input by the input section 801 to the sharing management server 101. With this arrangement, the riding request registration is possible. The receiver 803 receives the information of the user A from the sharing management server 101, in response to the request transmitted by the transmitter 802. The display controller 804 controls the display screen 805 that displays the information of user A received by the receiver 803. The CPU 501 controls the display controller 804 by executing the programs stored in the ROM 502 and the RAM 503 or the like shown in FIG. 5. The display screen 805 realizes its function with the display 504 shown in FIG. 5, for example.

The input section 806 inputs the consent of the user B to share the taxi, in response to the information of the consenting user A that is displayed on the display screen 805. The input section 806 realizes its function with the ten-key 507 or the cursor instruction section 508, for example. The transmitter 807 transmits the consent of user B input by the input section 806 to the sharing management server 101. Based on this, the negotiation of sharing the taxi ends, and the user B can share the taxi with user A. The receiver 803 and the transmitters 802 and 807 realize their functions with the communication controller 506 shown in FIG. 5. The CPU 501 controls the operation of the receiver 803 and the transmitters 802 and 807 by executing the programs stored in the ROM 502 and the RAM 503 or the like shown in FIG. 5.

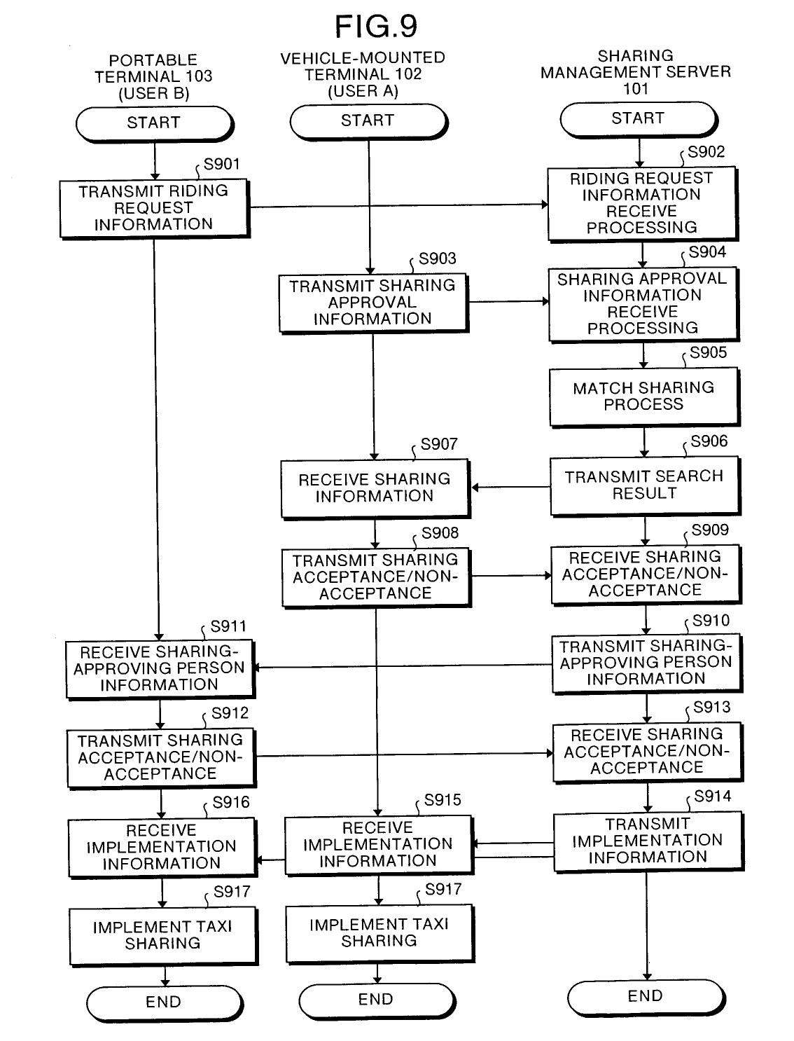

FIG. 9 is a flowchart that shows the interaction between the sharing management server 101, the terminal 102 and the portable terminal 103. The portable terminal 103 first transmits the request of user B for sharing the taxi that to the sharing management server 101 (step S901). The sharing management server 101 receives the riding request of user B from the portable terminal 103 (step S902). The terminal 102 then transmits the approval by user A to the sharing management server 101 (step S903). The sharing management server 101 receives the sharing approval of user A from the terminal 102 (step S904), and matches the request of user B with the sharing approval of user A (step S905) Based on the result of the matching, the sharing management server 101 transmits the user B information to the terminal 102 (step S906).

The terminal 102 receives the user B information from the sharing management server 101 (step S907). The terminal 102 transmits the information about whether the sharing of taxi with the user B is to be accepted, to the sharing management server 101, based on the received sharing information (step S908). The sharing management server 101 receives the information about whether the sharing is to be accepted from the terminal 102 (step S909). When the sharing has been accepted, the sharing management server 101 transmits the user A information to the portable terminal 103 (step S910).

The portable terminal 103 receives the user A information from the sharing management server 101. The portable terminal 103 transmits the information about whether the sharing of the taxi with the user A is acceptable to the sharing management server 101, in response to the received user A information (step S912). The sharing management server 101 receives the information about whether the sharing of the taxi is consented by user B (step S913). When sharing of the taxi is consented, the sharing management server 101 transmits the sharing implementation information to both the terminal 102 and the portable terminal 103 (step S914). Both the terminal 102 and the portable terminal 103 receive the sharing implementation information (steps S915 and S916), and implement the taxi sharing (step S917).

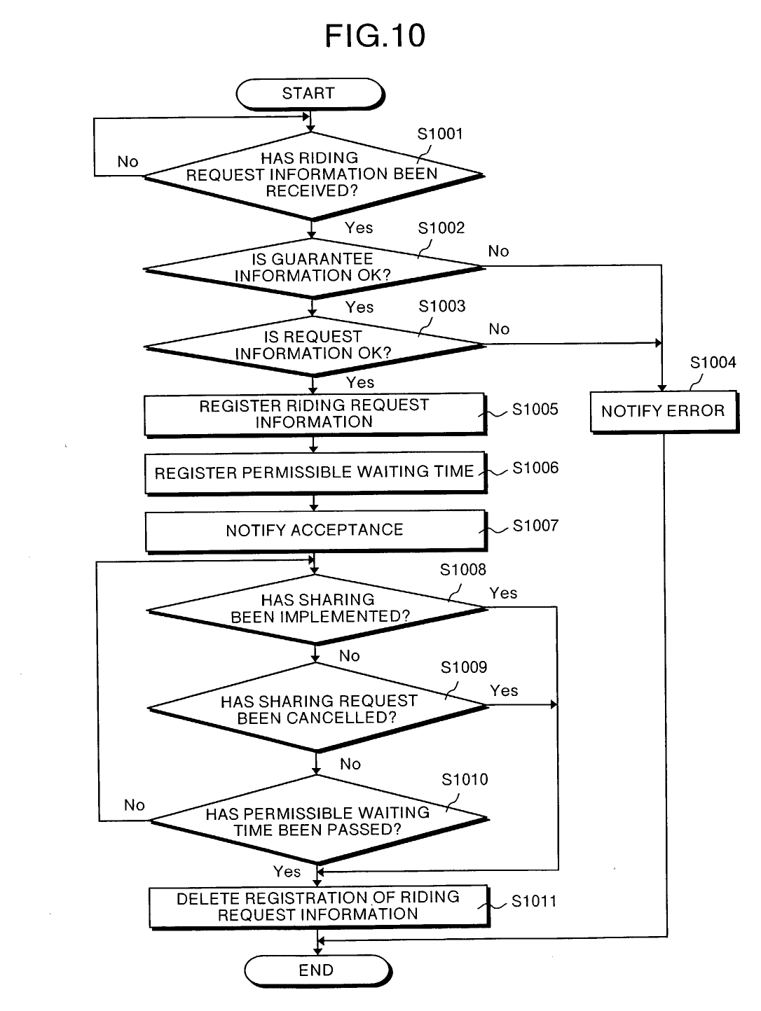

FIG. 10 is the flowchart that shows the process of the sharing management server 101 in relation with the portable terminal 103 relating to the embodiment of the present invention. In FIG. 10, the sharing management server 101 first decides whether the request has been received from the user B (step S1001). When the request has been received from the user B, (Yes at step S1001), the sharing management server 101 decides whether the guarantee information of the user B satisfies a predetermined condition (step S1002). For example, the sharing management server 101 checks the existence of the predetermined electronic signature. The sharing management server 101 also checks whether there is an input of a desired time of riding a taxi, a permissible waiting time, gender of the user B, smoking/non-smoking, and whether the user B had alcohol (step S1003), for example.

When at least one of the conditions at step S1002 and step S1003 has not been satisfied (No at step S1002, or No at step S1003), the sharing management server 101 notifies an error to the user B (step S1004), and completes the process. When the conditions at step S1002 and step S1003 have been satisfied (Yes at step S1002, and Yes at step S1003), the sharing management server 101 registers the information (step S1005). Further, the sharing management server 101 registers the information relating to the permissible waiting time included in the request (step S1006). Then, the sharing management server 101 notifies acceptance to the user B (step S1007).

The sharing management server 101 decides whether the user B has shared the taxi (step S1008). When the user B has shared the taxi (Yes at step S1008), the system control proceeds to step S1011. When the user B has not shared the taxi (No at step S1008), the sharing management server 101 decides whether the user B has cancelled the request for the riding (step S1009). When the user B has cancelled the request for the riding (Yes at step S1009), the system control proceeds to step S1011. When the user B has not cancelled the request for the riding (No at step S1009), the sharing management server 101 decides whether the permissible waiting time registered at step S1006 has passed (step S1010). When the permissible waiting time has not passed at step S1010 (No at step S1010), the system control proceeds to step S1008, and each process from steps S1008 to S1010 is repeated. When the permissible waiting time has passed at step S1010 (Yes at step S1010), the system control proceeds to step S1011. At step S1011, the sharing management server 101 deletes the registration of the request, and completes the process.

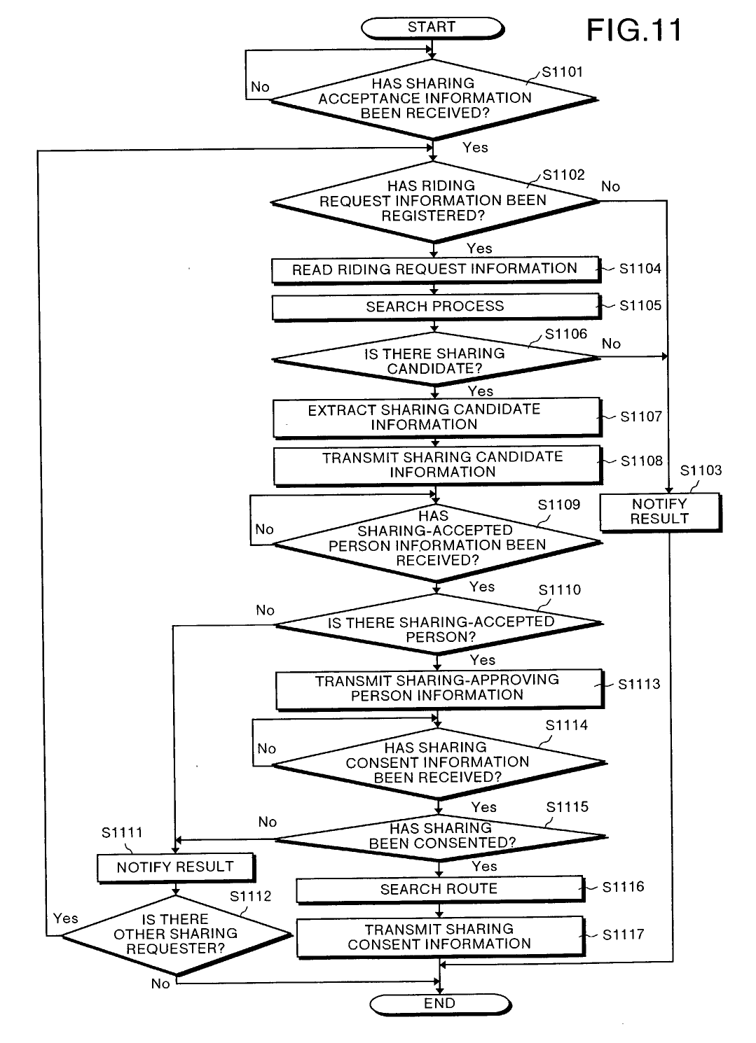

FIG. 11 is the flowchart that shows the process of the sharing management server 101 in relation with the terminal 102 relating to the embodiment of the present invention. The sharing management server 101 decides whether the sharing approval is received from the user A (step S1101). When the sharing approval is received from the user A (Yes at step S1101), the sharing management server 101 decides whether the request is registered (step S1102) When the request has not been registered (No at step S1102) the sharing management server 101 notifies this effect to the user A, and completes the process (step S1103). When the request is registered at step S1102 (Yes at step S1102), the sharing management server 101 reads the registered request (step S1104), searches the read request (step S1105). The sharing management server 101 decides whether there is a user B who would like to share the taxi (step S1106). When there is no such user B (No at step S1106), the sharing management server 101 notifies it to the user A (step S1103) and ends the process.

When there is a user B who would like to share the taxi (Yes at step S1106), the sharing management server 101 extracts the information of the user B (step S1107). The sharing management server 101 transmits the information of the user B to the user A (step S1108). The sharing management server 101 decides whether the consenting person information is received from the user A (step S1109). When the consenting person information is received (Yes at step S1109), the sharing management server 101 checks the existence of the user B who has been accepted to share the taxi (step S1110).

When there is no consenting person at step S1110 (No at step S1110), the sharing management server 101 notifies this effect (step at S1111), and decides whether there is another user B requesting to share the taxi (step S1112). When there is another user B who wants to share the taxi (Yes at step S1112), the system control returns to step S1102, and the sharing management server 101 carries out the similar process from step S1102. When there is no other person who wants to share the taxi at step S1112 (No at step S1112), the sharing management server 101 completes the process.

When there is a user A consenting to share the taxi at step S1110 (Yes at step S1110), the sharing management server 101 transmits the information relating to the user A to the user B as the consenting person (step S1113). Then, the sharing management server 101 decides whether the sharing consent is received from the user B (step S1114). When the sharing consent is received (Yes at step S1114), the sharing management server 101 decides whether the consent received is the acceptance to share the taxi (step S1115).

When it is not acceptable to share the taxi at step S1115 (No at step S1115), the system control proceeds to step S1111 and the sharing management server 101 notifies this effect (step S1111). The sharing management server 101 decides whether there is another user B who wants to share the taxi (step S1112). When there is another user B who wants to share the taxi (Yes at step S1112), the system control returns to step S1102. When there is no other person who wants to share the taxi (No at step S1112), the sharing management server 101 ends the process.

When it is acceptable to share the taxi at step S1115 (Yes at step S1115), the sharing management server 101 searches for an optimum route based on the current position of the user B, the destinations of user A and user B, and other information such as road congestion information and the like (step S1116). The sharing management server 101 transmits the sharing consent and the route information retrieved at step S1116 to the user A, and to the user B when necessary (step S1117), and completes the process. By carrying out the process, it becomes possible to efficiently arrange the sharing of a taxi.

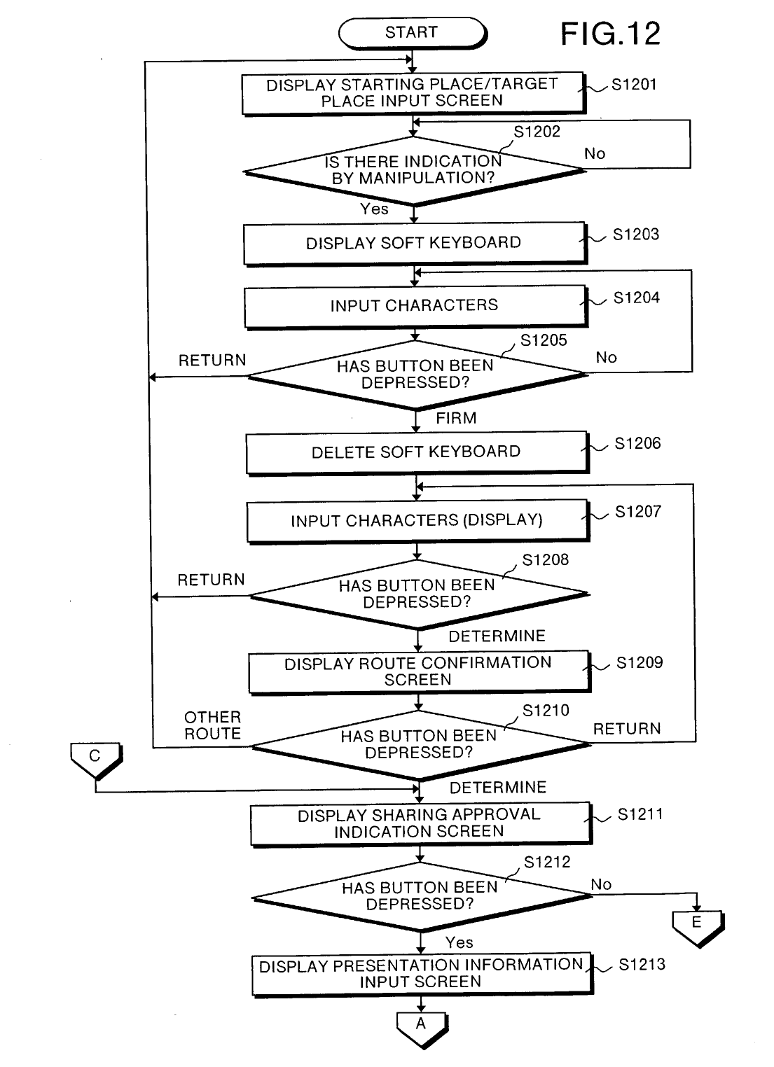

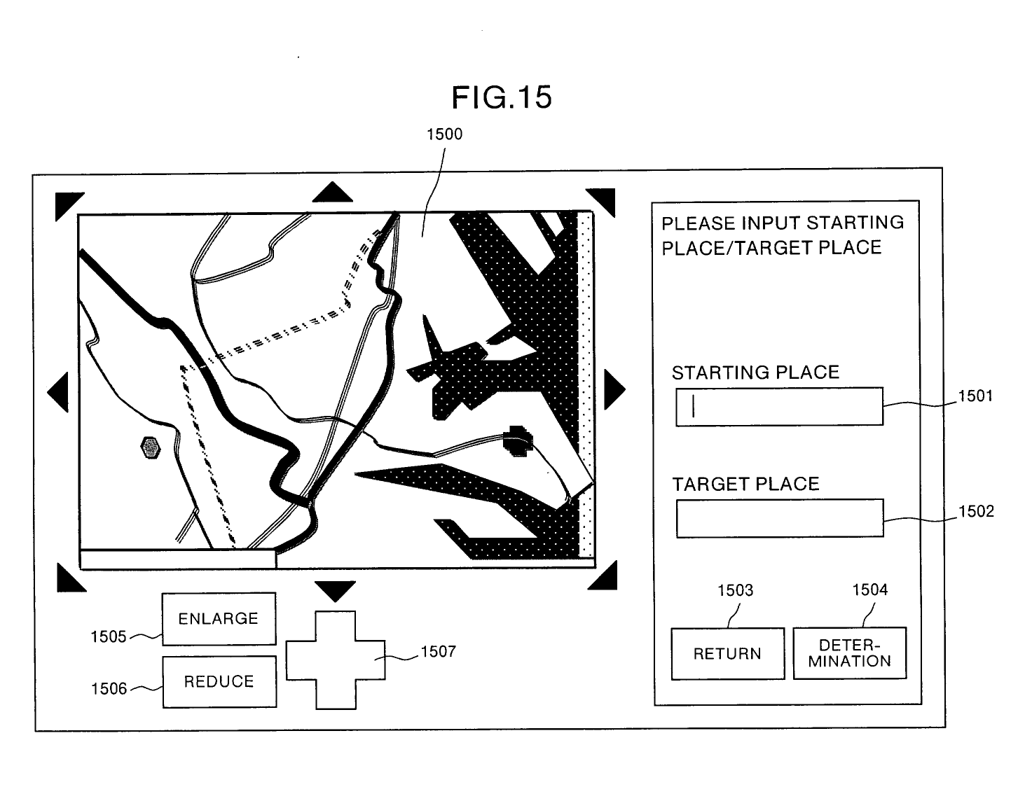

The process of the terminal 102 as a taxi sharing approval apparatus is explained next. FIG. 12 to FIG. 14 are flowcharts which show the process of the taxi sharing approval apparatus relating to the embodiment of the present invention. In FIG. 12, an input screen indicating the starting place, a current position, a destination as shown in FIG. 15 is displayed (step S1201).

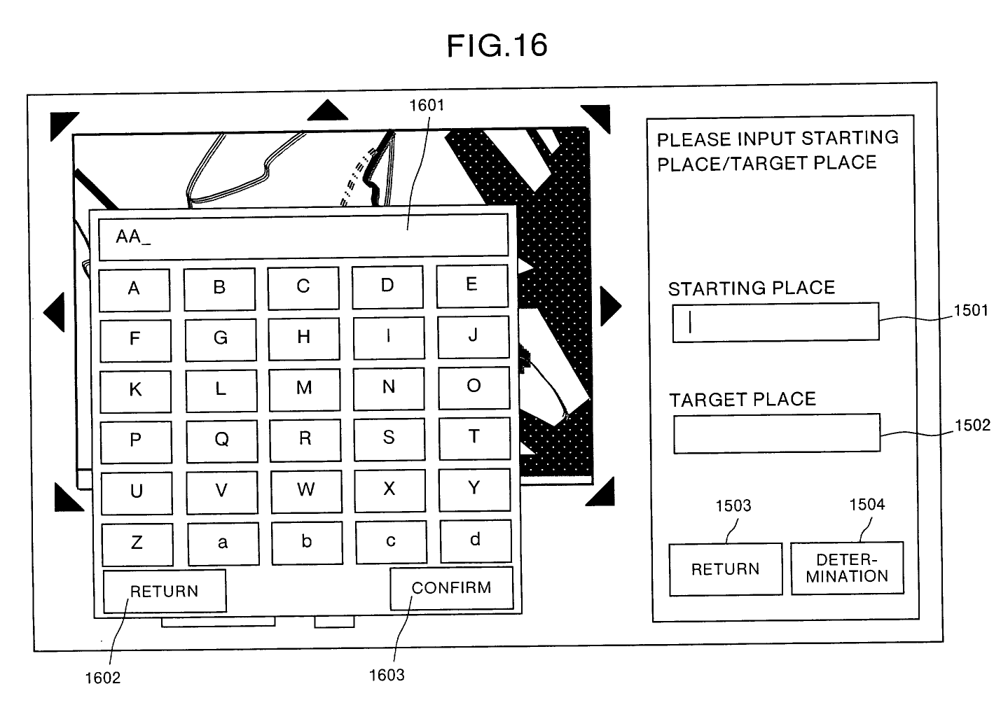

FIG. 15 is an explanatory diagram that shows one example of display contents of the display screen 706 of the terminal 102. FIG. 16 to FIG. 32 are also similar explanatory diagrams. In FIG. 15, are ference number 1500 denotes a map that displays a starting place and a target place, 1501 denotes a starting place input column that indicates the current position, and 1502 denotes a destination input column. It is possible to enlarge or reduce the map 1500 with an enlarge button 1505 and a compress button 1506, respectively. It is also possible to move the display area by the operation of a cross-key 1507.

When the input screen of starting place and destination is displayed, the terminal 102 checks if an input is made to the starting place input column 1501 or the target place input column 1502 (step S1202). When there is an indication that an input is made (Yes at step S1202), the terminal 102 displays a soft keyboard 1601 as shown in FIG. 16 (step S1203) The soft keyboard 1601 may consist of alphabet characters or kana characters. The characters are input using the soft keyboard 1601 (step S1204). After the characters have been input, a return button 1602 or a confirmation button 1603 is pressed (step S1205). When neither of the buttons are pressed (No at step S1205), the system control returns to step S1204, and the characters are input continuously. When the return button 1602 is pressed (step S1205), the system control returns to step S1201.

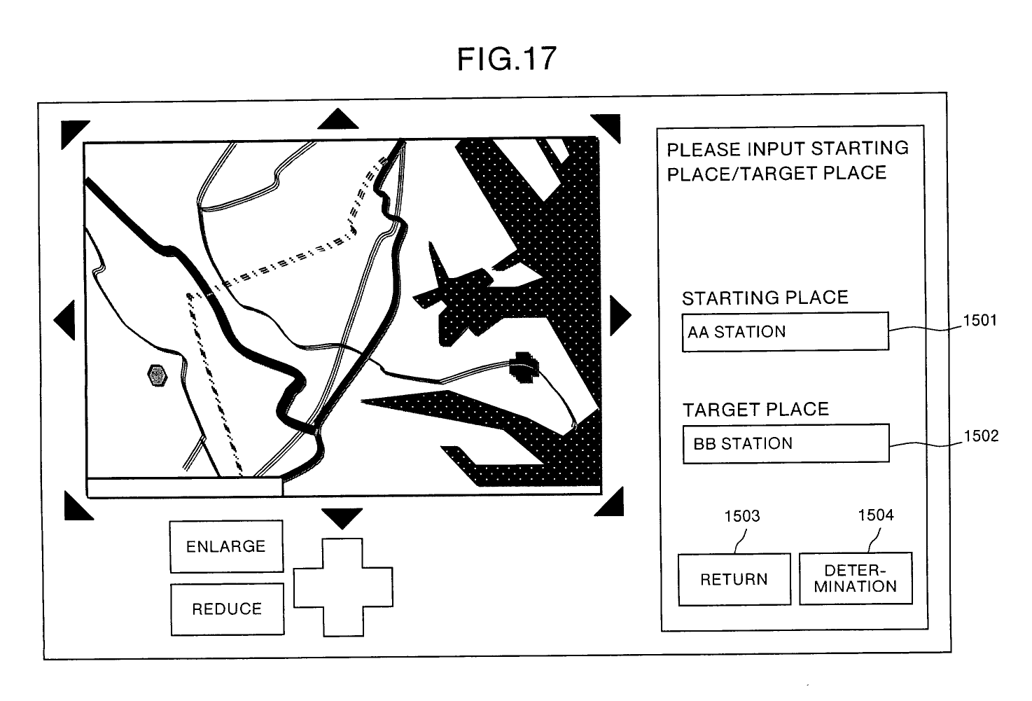

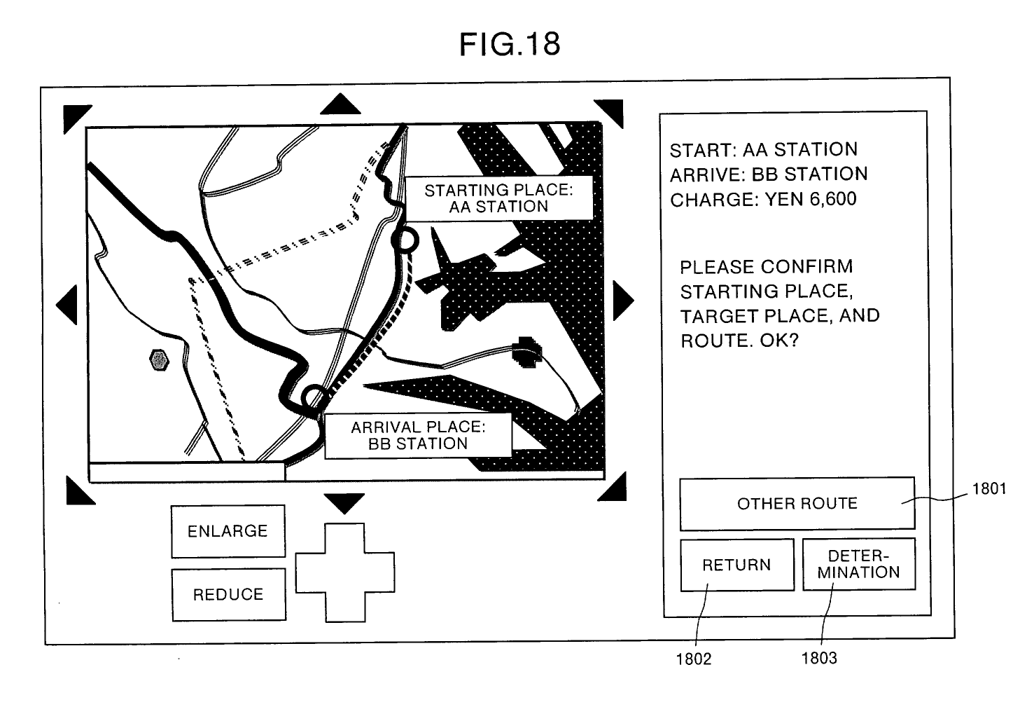

When the confirmation button 1603 is pressed (step S1205), the soft keyboard 1601 is erased (step S1206). Then, as shown in FIG. 17, the characters input at step S1204 are displayed in the starting place input column 1501 and the target place input column 1502 (step S1207). The terminal 102 decides whether either a return button 1503 or a determination button 1504 is pressed (step S1208). When the return button 1503 is pressed (step S1208), the system control system control returns to step S1201. When the determination button 1504 is pressed (step S1208), the terminal 102 displays a route confirmation screen as shown in FIG. 18 (step S1209). The route confirmation screen as shown in FIG. 18 displays a starting place AA station, a target place BB station, and charge of Yen 6,600. The positions of the starting place and the target place are displayed on the map 1500. Next, the terminal 102 checks whether any one of another route button 1801, a return button 1802, and a determination button 1803 is pressed (step S1210) When the other route button 1801 is pressed (step S1210) the system control returns to step S1201 and it is possible to change the setting of the route again.

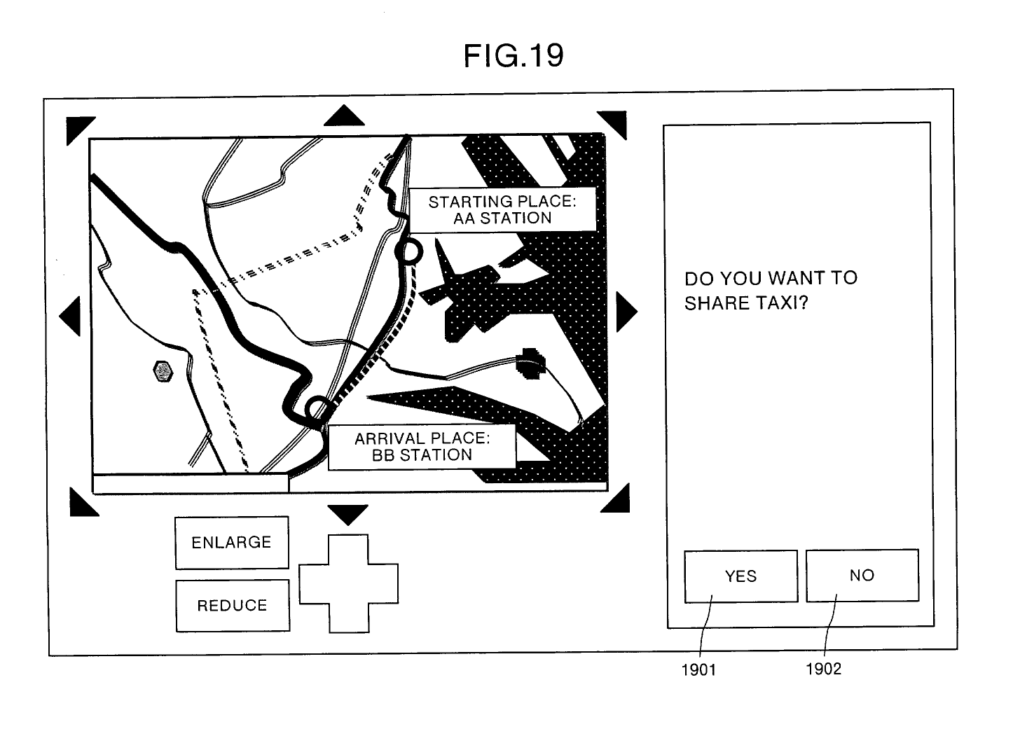

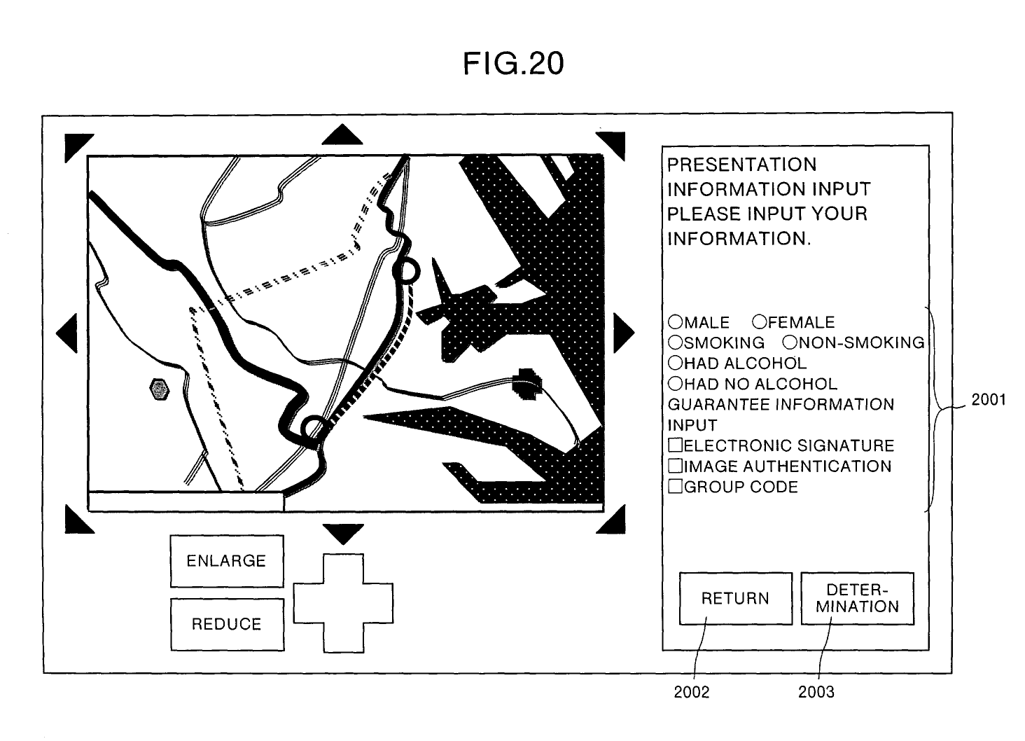

When the return button 1802 is pressed (step S1210) the system control returns to step S1207, and the display screen shown in FIG. 17 is obtained. When the determination button 1803 is pressed (step S1210), a taxi sharing approval indication screen as shown in FIG. 19 is displayed (step S1211). The terminal 102 decides which one of a Yes button 1901 and a No button 1902 is pressed, in response to the question “Do you want to share the taxi?” (step S1212). When the No button 1902 is pressed at step S1212 (step S1212), the terminal 102 completes the process. When the Yes button 1901 is pressed (step S1212), a presentation information input screen as shown in FIG. 20 is displayed (step S1213) The presentation information 2001 such as male or female, smoking or non-smoking, and if the person had alcohol are input with a radio button as shown in FIG. 20. The guarantee information such as electronic signature, image authentication, and group code can also be selected by checking the respective check boxes.

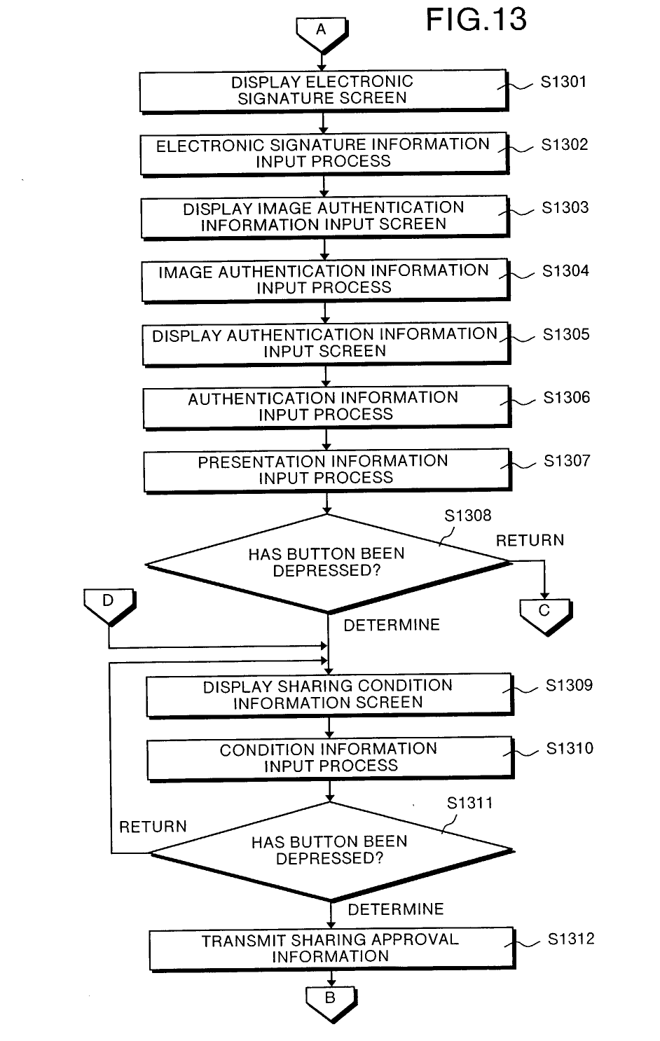

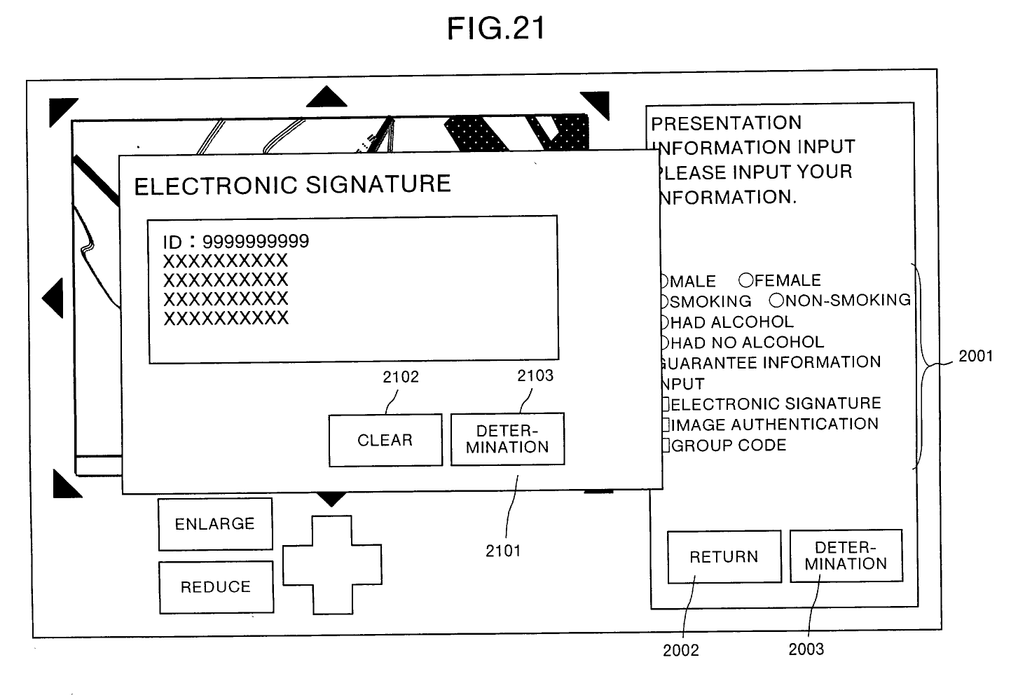

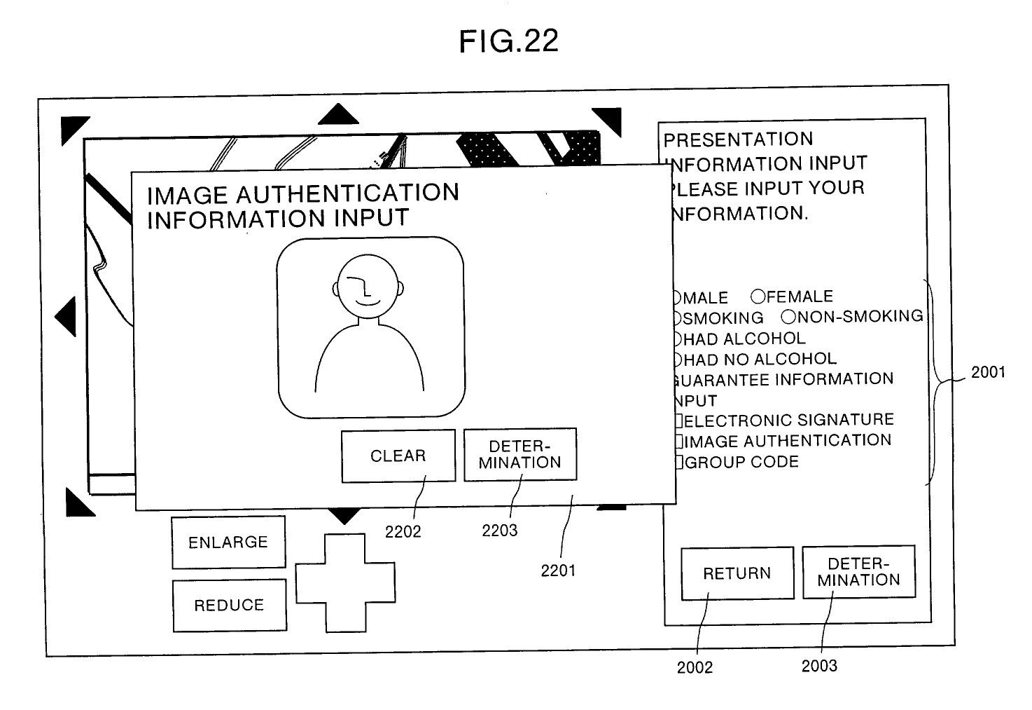

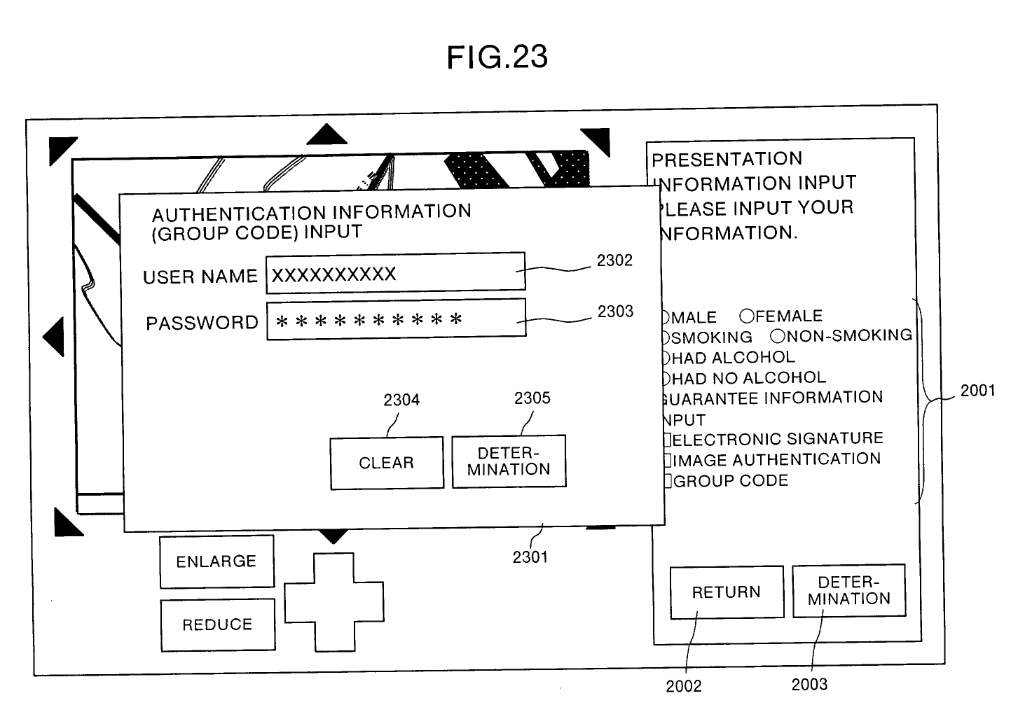

When the check box of the electronic signature is checked in FIG. 13, an electronic signature screen 2101 as shown in FIG. 21 is displayed (step S1301). The predetermined electronic signature information is input on the electronic signature screen 2101 (step S1302). When a clear button 2102 is pressed, the input information is cleared, and when a determination button 2103 is pressed, the input information is confirmed. When the check box of the image authentication is checked, an image authentication information input screen 2201 as shown in FIG. 22 is displayed (step S1303). The information to authenticate the image of the user is input at step S1304. When the check box of the group code is checked, an authentication information input screen 2301 as shown in FIG. 23 is displayed (step S1305). The authentication information is input to a user name input column 2302 and a password input column 2303 (step S1306). At the time of inputting characters of which display is omitted, the soft keyboard 1601 as shown in FIG. 16 is displayed. The characters are input using the soft keyboard 1601.

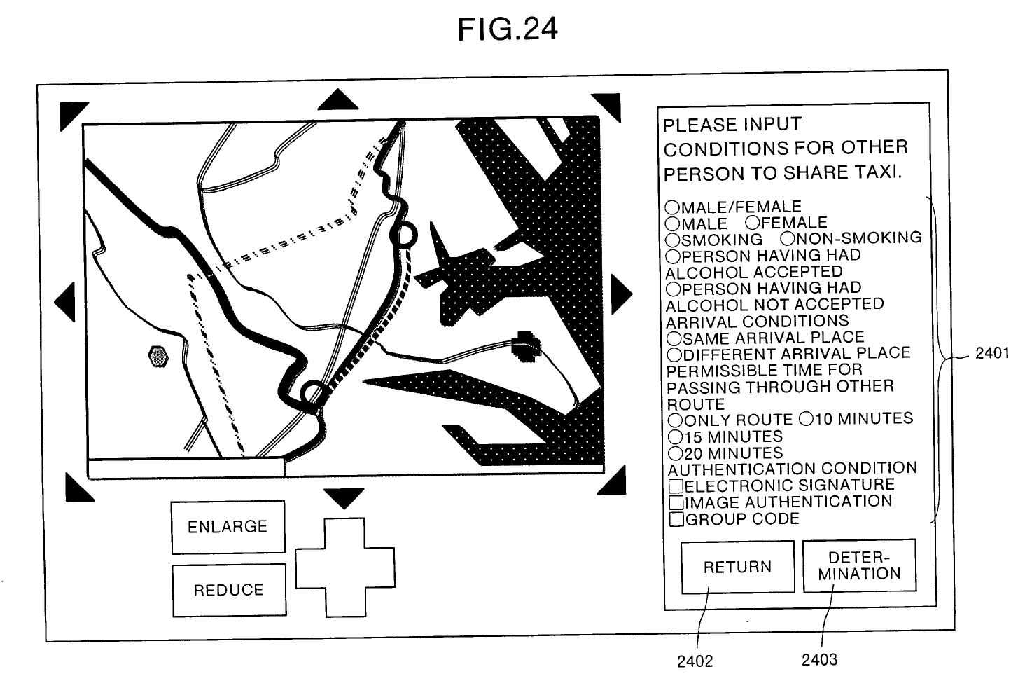

Further, the above presentation information 2001 is input (step S1307). The terminal 102 checks whether either are turn button 2002 or a determination button 2003 is pressed (step S1308). When the return button 2002 is pressed (return at step S1308), the system control returns to step S1211 shown in FIG. 12. When the determination button 2003 is pressed (determination at step S1308), a sharing condition information screen as shown in FIG. 24 is displayed (step S1309).

As shown in FIG. 24, the information relating to conditions for the person to share the taxi 2401, male and female, male or female, smoking or non-smoking, if the person who had alcohol is accepted, whether the same arrival place or a different arrival place, and a permissible time for passing through another route as only the route/10 minutes/15 minutes/20 minutes, are selected by a radio button (step S1310). The electronic signature, image authentication, and group code can be selected by the respective check boxes as the guarantee information. The terminal 102 checks whether a return button 2402 or a determination button 2403 is pressed (step S1311). When the return button 2402 is pressed (step S1311), the system control returns to step S1309. When the determination button 2403 is pressed (determination at step S1311), the terminal 102 transmits the information relating to conditions to share the taxi 2401 that is input at step S1310 (step S1312).

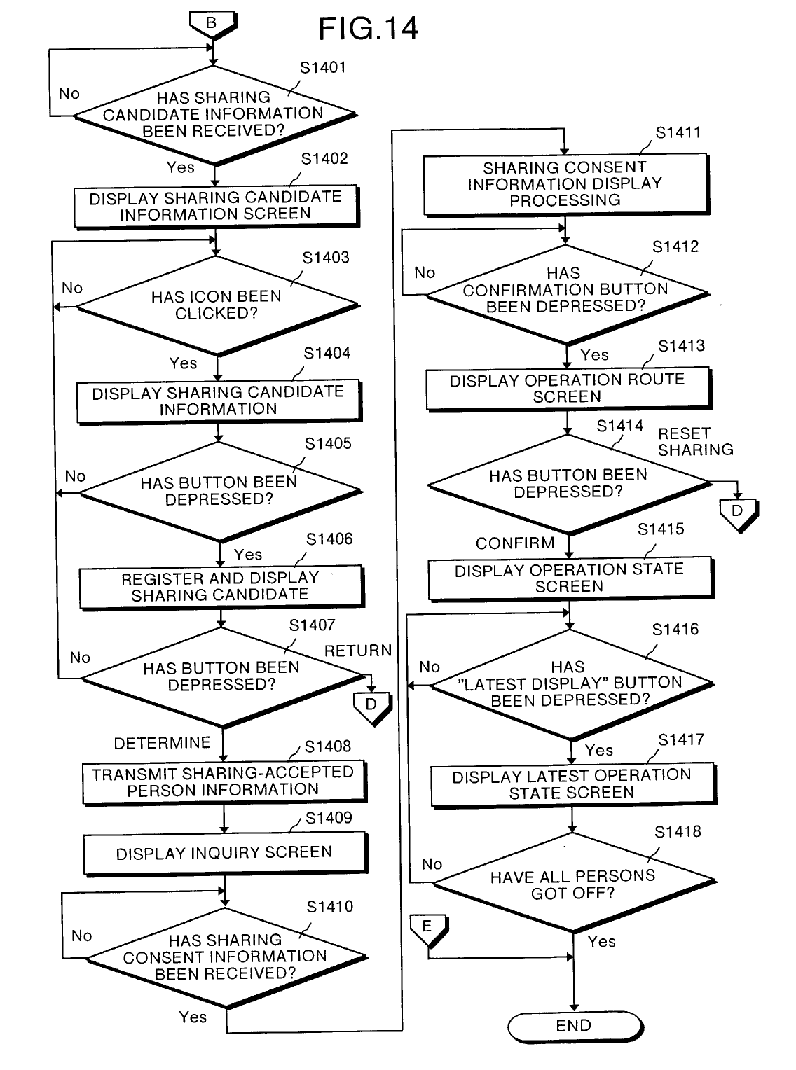

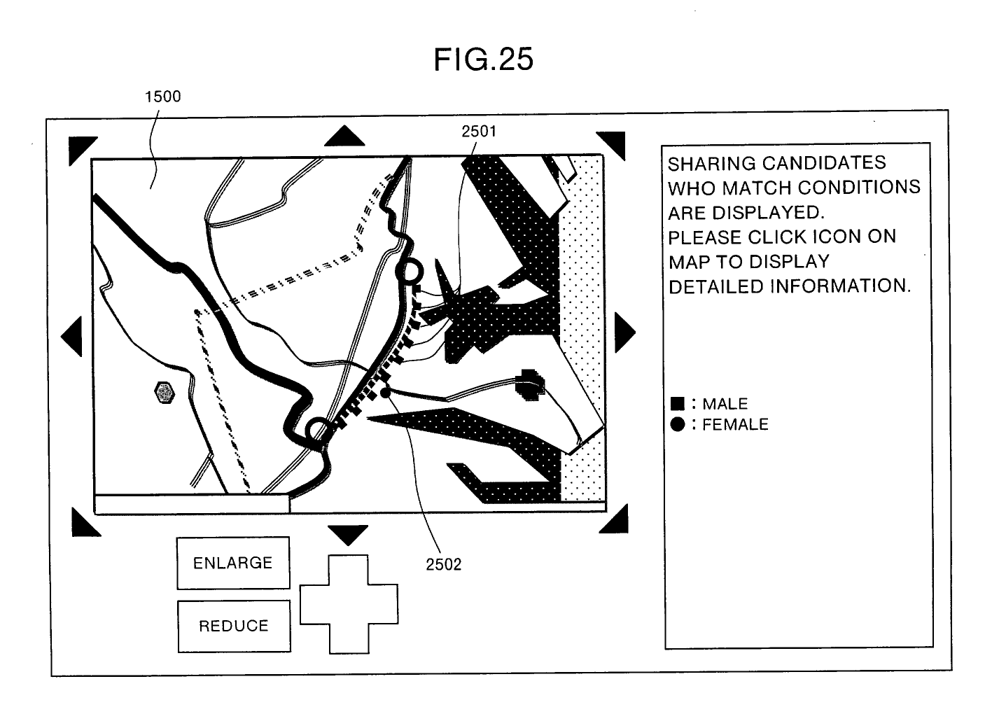

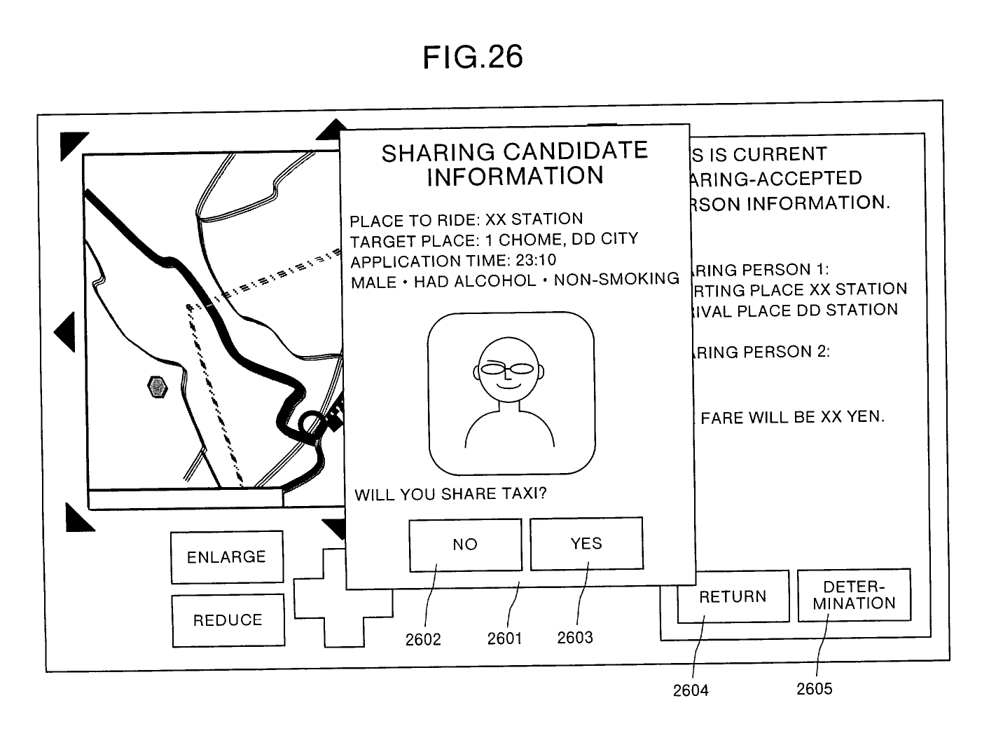

Next, as shown in FIG. 14, the terminal 102 decides whether the sharing candidate information is received in response to the transmitted sharing approval (step S1401) When the sharing candidate information is received (Yes at step S1401), the terminal 102 displays a sharing candidate information screen as shown in FIG. 25 (step S1402). In FIG. 25, whether a sharing candidate is male or female is identified using square icon 2501 indicating male, and a circular icon 2502 indicating female, and the current position is displayed on the map 1500. The terminal 102 checks if the optional icons 2501 and 2502 that are displayed on the map 1500 is clicked (step S1403). When the icon is clicked (Yes at step S1403), the sharing candidate information 2601 is displayed as shown in FIG. 26 (step S1404) The terminal 102 checks whether a No button 2602 or a Yes button 2603 is pressed (step S1405).

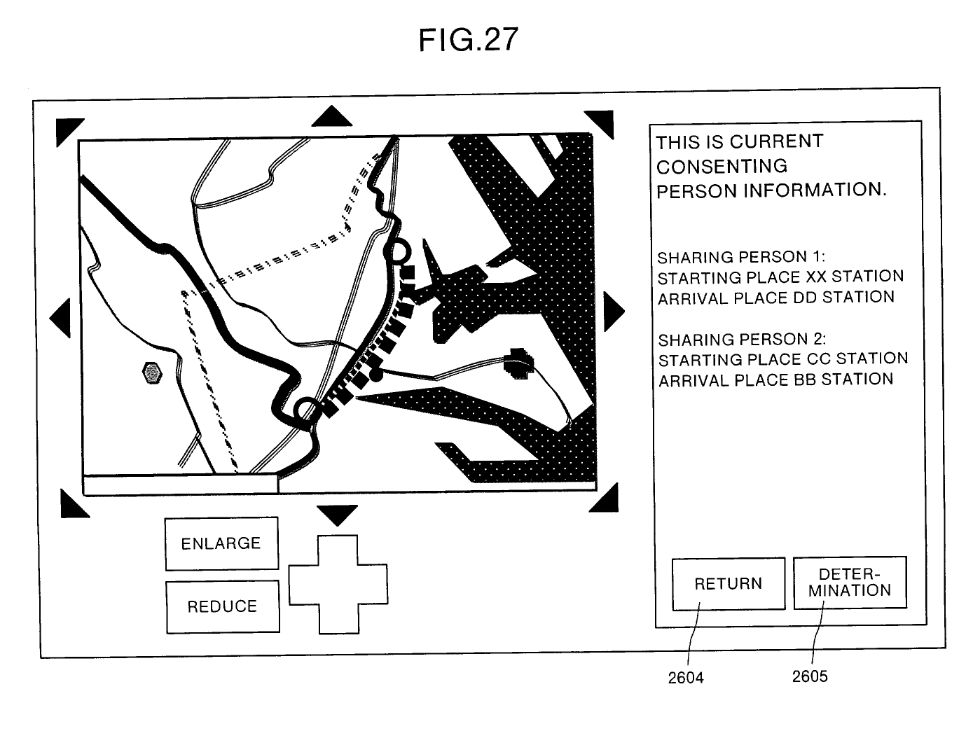

When the NO button 2602 is pressed at step S1405 (No at step S1405), the system control returns to step S1403, and the terminal 102 waits for the click of another icon. When the Yes button 2603 is pressed (Yes at step S1405), the terminal 102 registers the consent of the sharing candidate, displays the registered person on the display screen as shown in FIG. 27 (step S1406), and proceeds to step S1407.

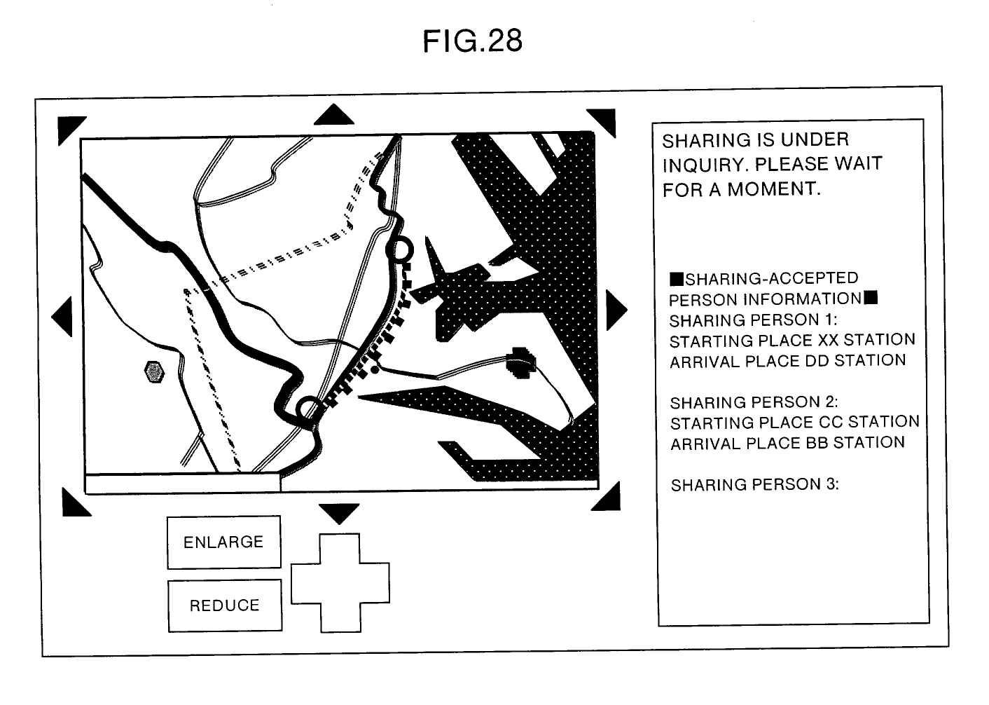

At step S1407, the terminal 102 checks whether a return button 2604 or a determination button 2605 is pressed. When neither of the buttons are pressed (No at step S1407), the system control returns to step S1403. When the return button 2604 is pressed (step S1407), the system control returns to step S1309 shown in FIG. 13. When the determination button 2605 is pressed (step S1407), the terminal 102 transmits the consenting person information (step S1408), and at the same time, displays an inquiry screen as shown in FIG. 28 (step S1409).

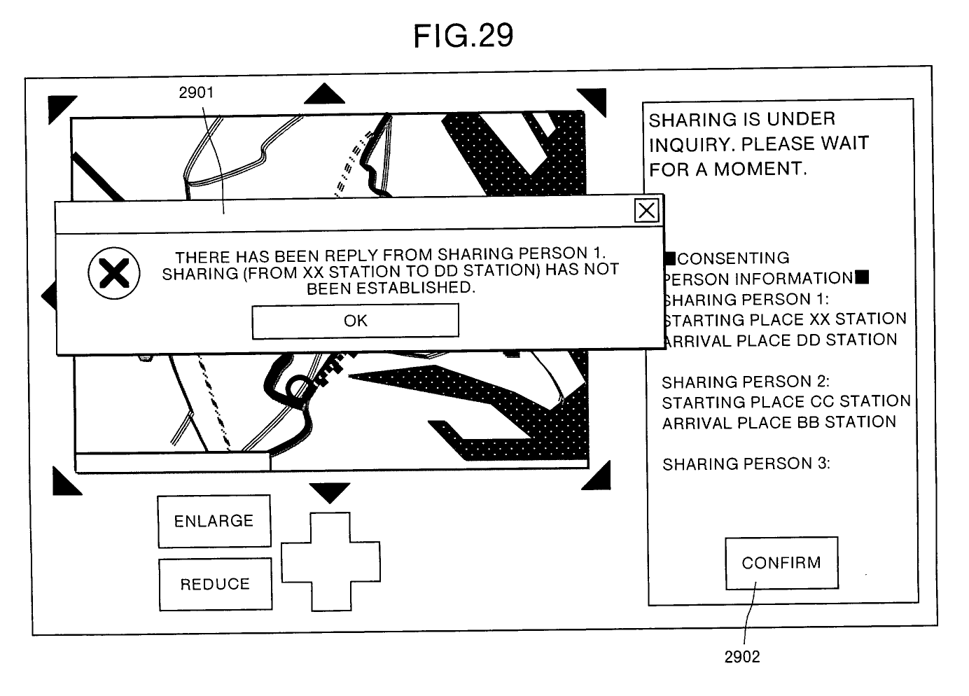

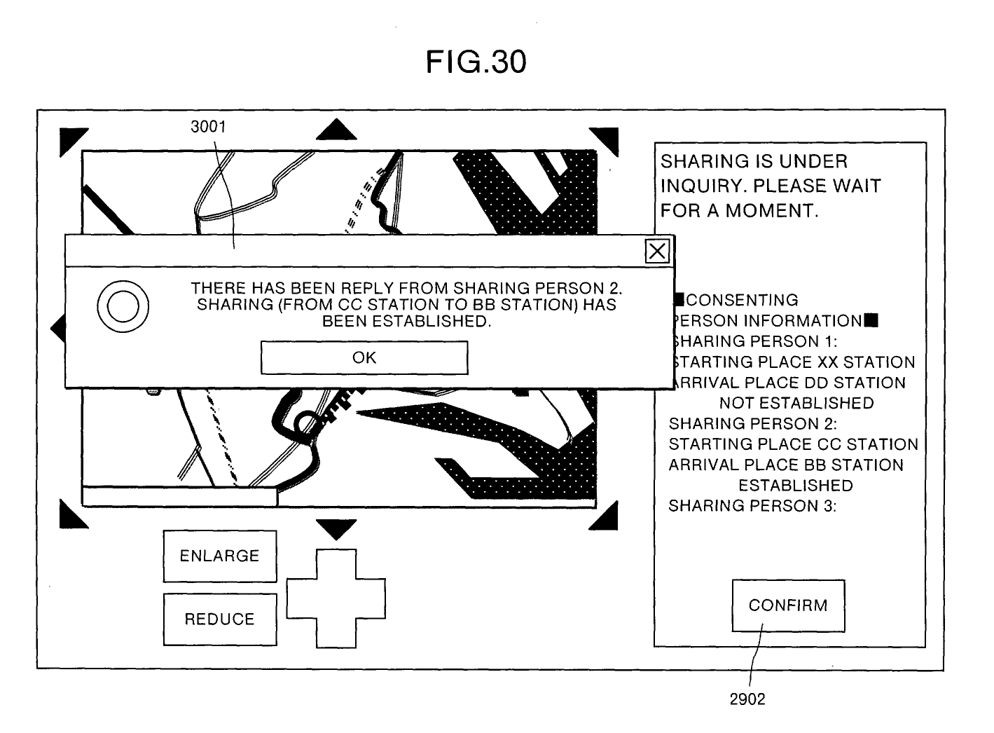

The terminal 102 decides whether the sharing consent is received (step S1410). When the sharing consent is received (Yes at step S1410), the terminal 102 displays the sharing consent (step S1411). To be more specific, the information from the consenting person relating to whether the sharing candidate has accepted or not accepted to share the taxi is displayed on pop-up screens 2901 and 3001 as shown in FIG. 29 or FIG. 30.

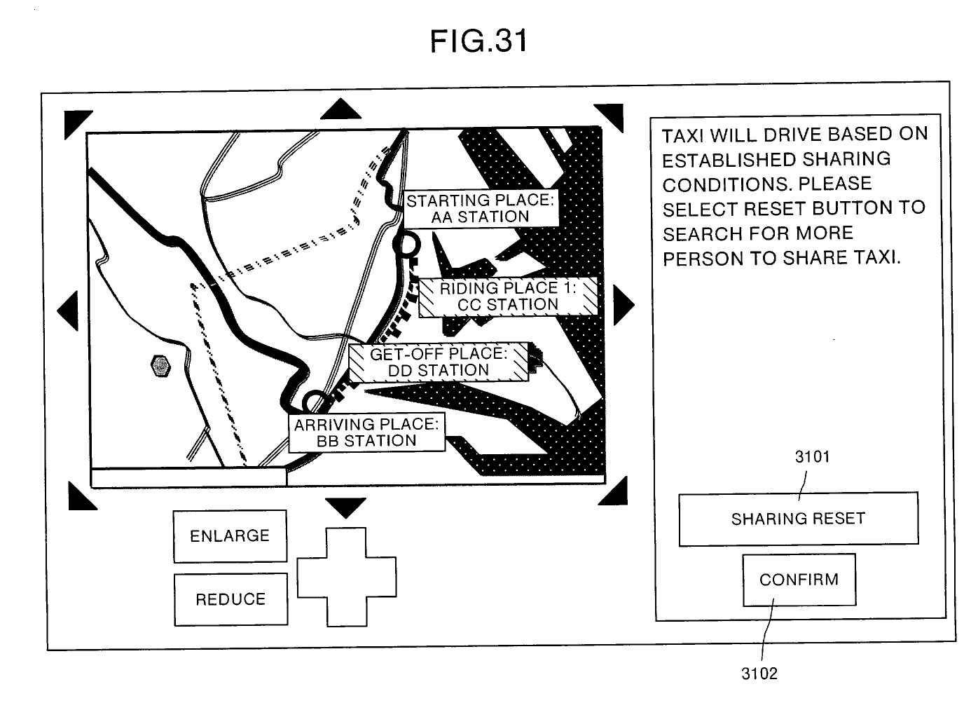

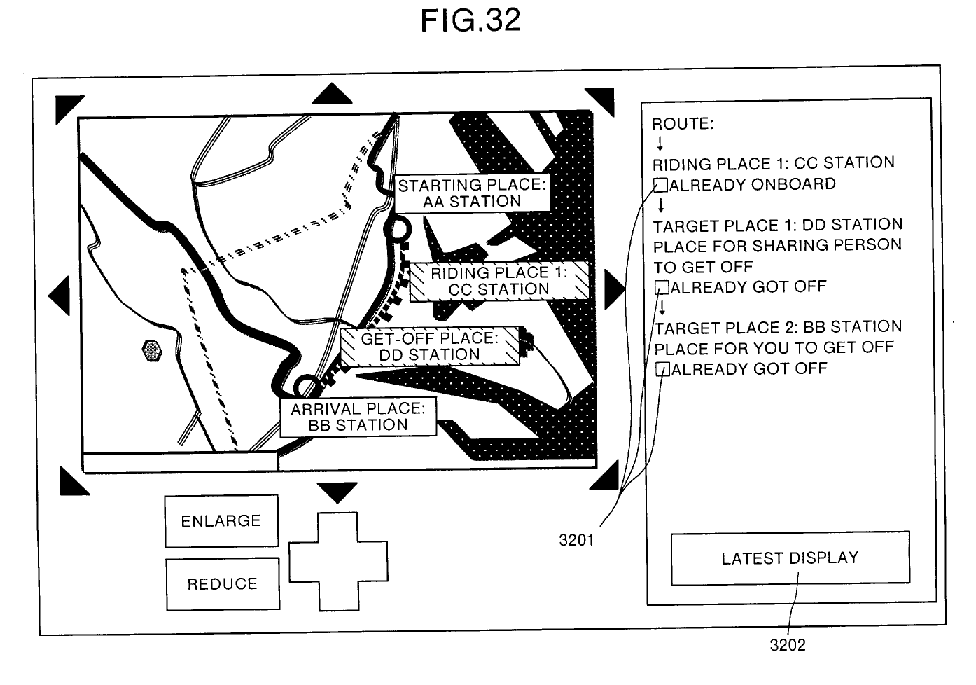

When a confirmation button 2902 is pressed (Yes at step S1412), a route screen as shown in FIG. 31 is displayed (step S1413). The route screen displays the positions of a starting place, a pick-up place, a get-off place, and an arrival place on the map 1500. Then, the terminal 102 checks whether a reset button 3101 or a confirmation button 3102 is pressed (step S1414). When the reset button 3101 is pressed at step S1414 (step S1414), the system control returns to step S1309 as shown in FIG. 13. When the confirmation button 3102 is pressed (step S1414), an operation status screen as shown in FIG. 32 is displayed (step S1415). The operation status screen displays the onboard and disembarkation status of each place in a check box 3201 to make the status of the operation clear.

The terminal 102 checks if a latest display button 3202 is pressed (step S1416). When the latest display button 3202 is pressed (Yes at step S1416), the latest operation status screen is displayed (step S1417). Then, the terminal 102 checks whether all persons have got off the taxi (step S1418). When all persons have not got off (No at step S1418), the system control returns to step S1416, and the process from steps S1416 to S1418 is carried out repeatedly. When all persons have got off the taxi (Yes at step S1418), the terminal 102 completes the process.

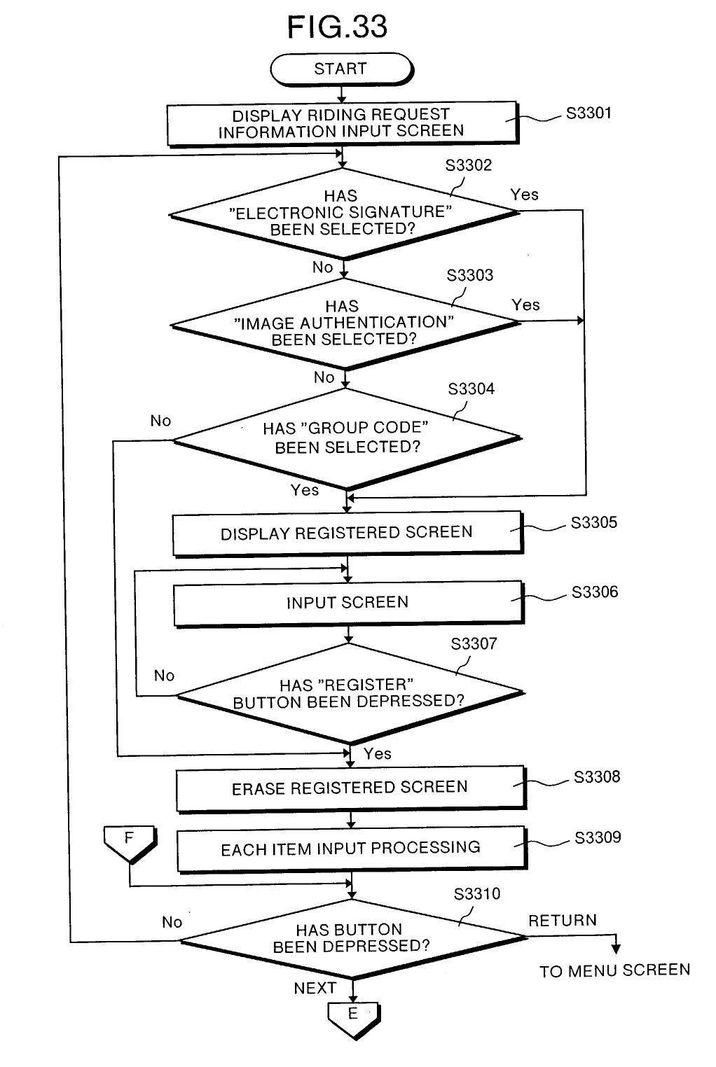

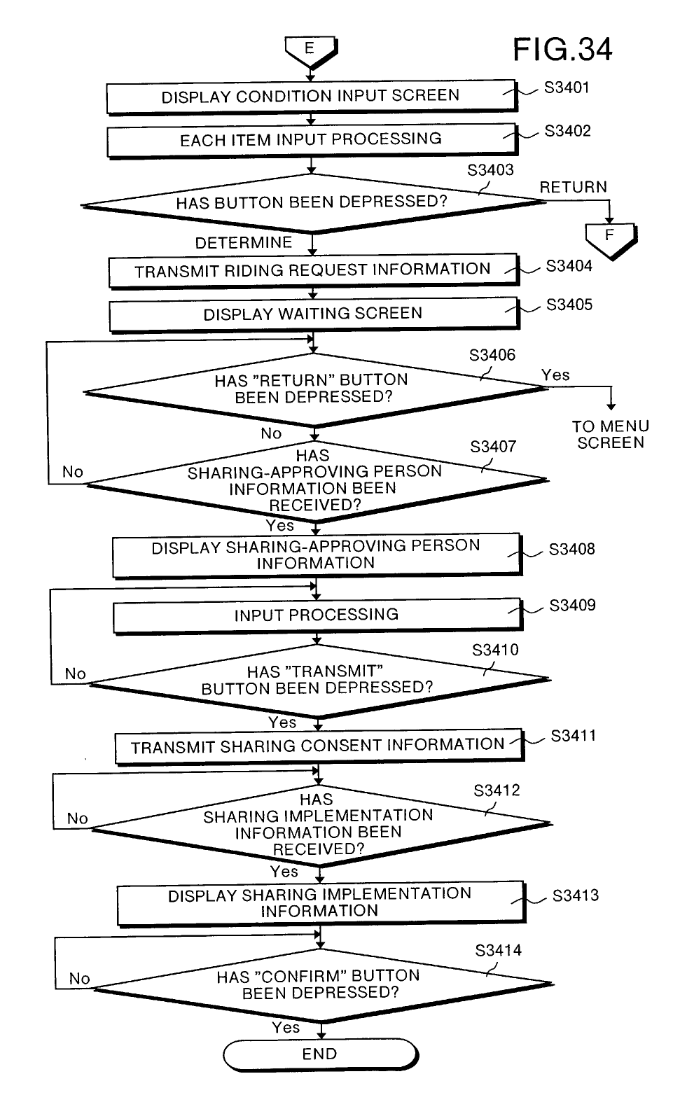

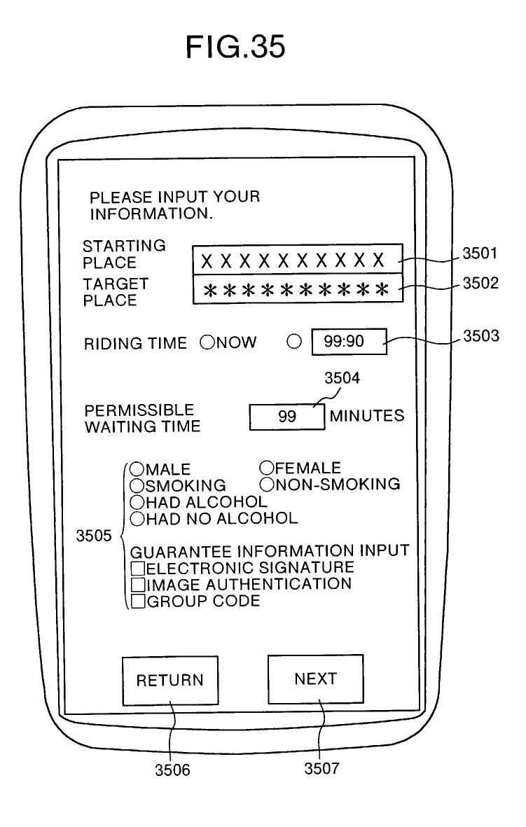

FIG. 33 and FIG. 34 are flowcharts showing the process of the portable terminal 103 relating to the embodiment of the present invention. As shown in FIG. 33, the portable terminal 103 first displays an input screen as shown in FIG. 35 (step S3301).

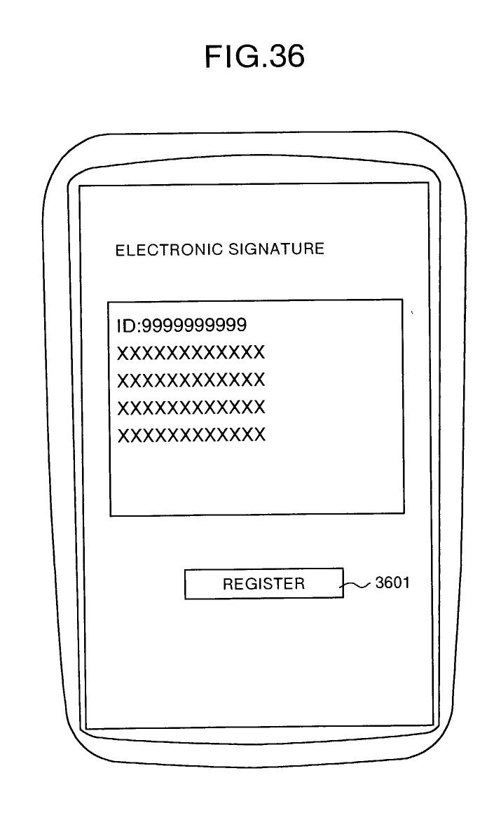

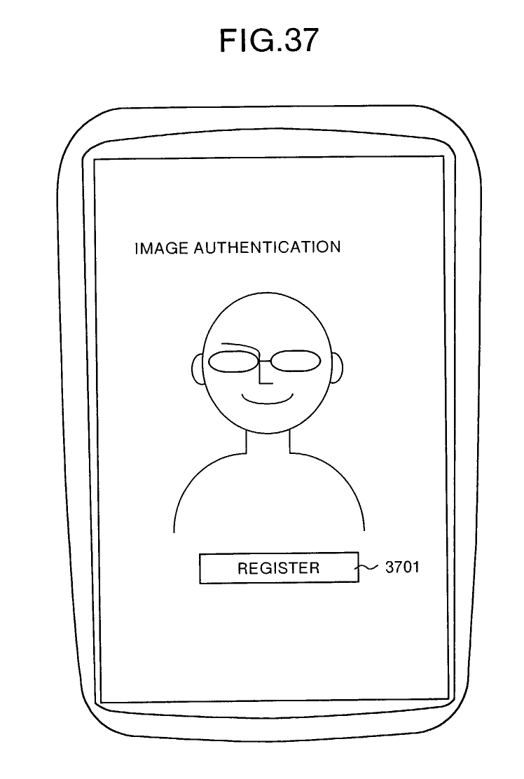

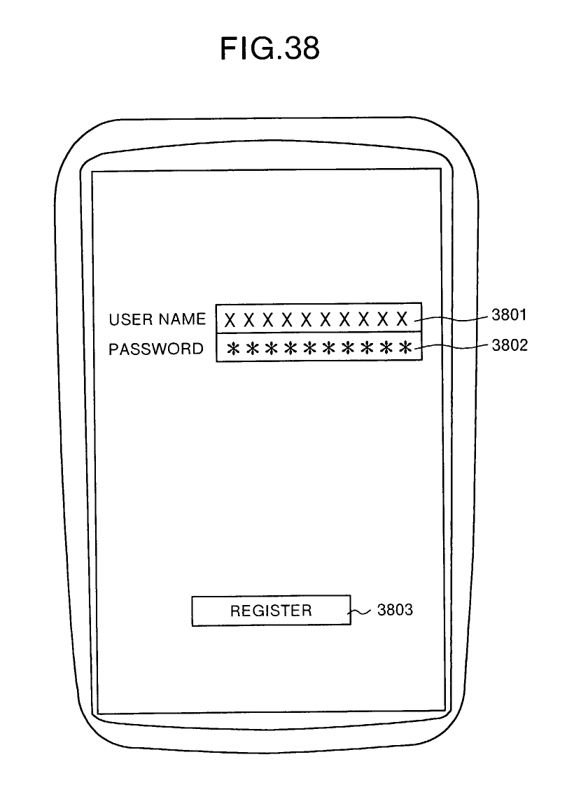

FIG. 35 is an explanatory diagram that shows the contents of the display screen 805. FIG. 36 to FIG. 42 also shows other similar examples. As shown in FIG. 35, the user B inputs a starting place or the current position into a starting place input column 3501. The user B inputs a destination into a destination input column 3502. The user B selects the radio button now or specifies the exact time in the time input column 3503 depending on the time that the user B wants to take the taxi. The user B inputs the permissible waiting time in minutes into a permissible waiting time input column 3504. The request 3505 is similar to the presentation information 2001, and therefore, the explanation is omitted. The contents of an electronic signature screen shown in FIG. 36 are similar to those of the electronic signature screen 2101 shown in FIG. 21. The contents of an image authentication information input screen shown in FIG. 37 are similar to those of the image authentication information input screen 2201 shown in FIG. 22. The contents of an authentication information input screen of group code shown in FIG. 38 are similar to those of the authentication information input screen 2301 shown in FIG. 28. Therefore, their explanations will also be omitted.

In the flowchart shown in FIG. 33, the portable terminal 103 decides at step S3302 whether the request electronic signature is selected in the check box (step S3302). When the request electronic signature is selected (Yes at step S3302), the electronic signature screen shown in FIG. 36 is displayed (step S3305). Similarly, the portable terminal 103 decides whether the image authentication is selected (step S3303). When the image authentication is selected (Yes at step S3303), the image authentication information input screen shown in FIG. 37 is displayed (step S3305). Similarly, the portable terminal 103 decides whether the group code is selected (step S3304). When the group code is selected (Yes at step S3304), the authentication information input screen shown in FIG. 38 is displayed (step S3305). The portable terminal 103 decides whether registration buttons 3601, 3701, and 3803 are pressed (step S3307). When the registration buttons 3601, 3701, and 3803 have not been pressed (No at step S3307), the system control returns to step S3306, and the input process is carried out repeatedly. When the registration buttons 3601, 3701, and 3803 have been pressed (Yes at step S3307), the registered screens from FIG. 36 to FIG. 38 are erased (step S3308), and the data shown in FIG. 35 is input (step S3309). Then, the portable terminal 103 checks if a return button 3506 or a next button 3507 is pressed (step S3310). When none of the buttons are pressed (No at step S3310), the system control returns to step S3302, and the process from step S3302 to step S3310 is carried out repeatedly. When the return button 3506 is pressed at step S3310 (return at step S3310), the system control returns to a menu screen not shown. When the next button 3507 is pressed (next at step S3310), the system control proceeds to step S3401 shown in FIG. 34.

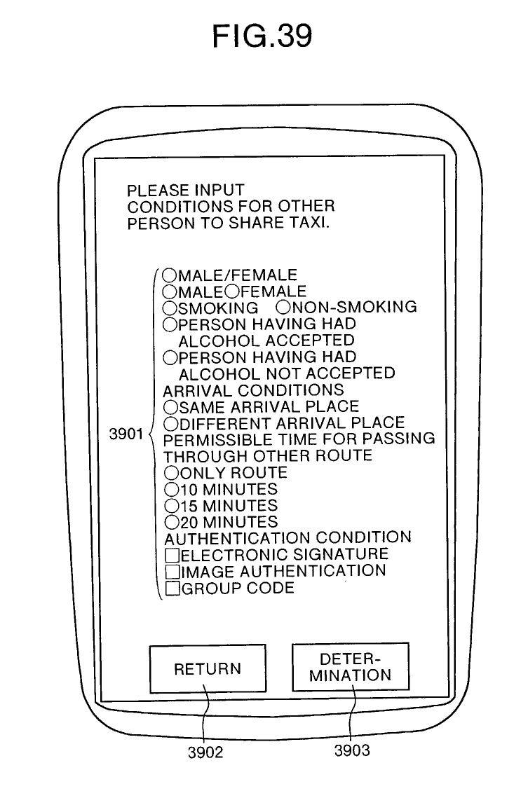

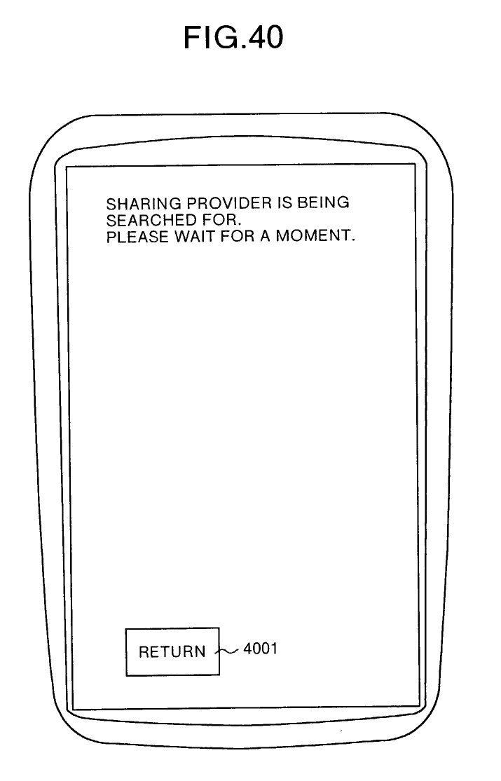

As shown in FIG. 34, first, a condition input screen as shown in FIG. 39 is displayed (step S3401). The user B inputs the conditions for sharing the taxi (step S3402). The information relating to the condition of the user A 3901 is similar to the conditions 2401, and therefore, the explanation of each item is omitted. The portable terminal 103 checks whether either a return button 3902 or a determination button 3903 is pressed (step S3403). When the return button 3902 is pressed (step S3403), the system control returns to step S3310 shown in FIG. 33. When the determination button 3903 is pressed (step S3403), the portable terminal 103 transmits the request of user B that includes the specified conditions (step S3404). At the same time, the portable terminal 103 displays a waiting screen as shown in FIG. 40 (step S3405).

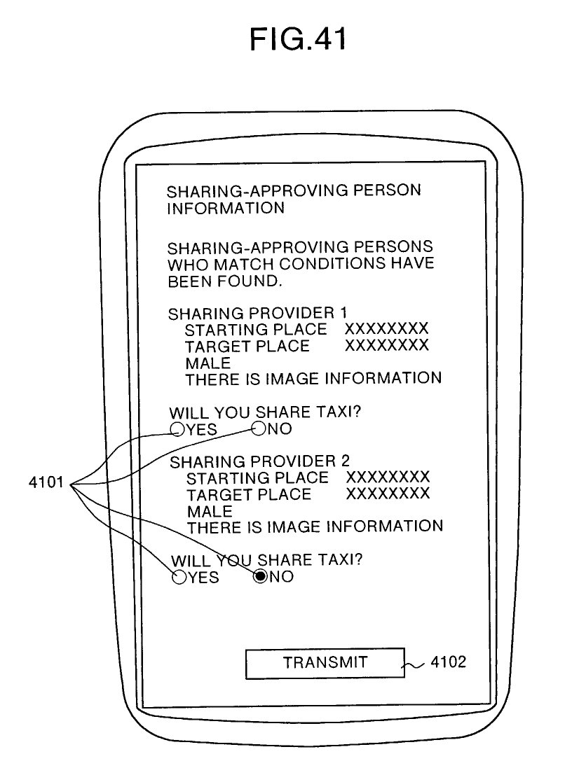

In the state that the waiting screen as shown in FIG. 40 is displayed, the portable terminal 103 checks if a return button 4001 is pressed (step S3406). When the return button 4001 is not pressed (No at step S3406), the portable terminal 103 waits for reception of the user A information as the waiting screen is displayed. When the return button 4001 is pressed (Yes at step S3406), a menu screen that is not shown in the diagrams is displayed, and the portable terminal 103 waits for reception of the user A information. The portable terminal 103 decides whether the user A information is received (step S3407). When the user A information has not yet been received (No at step S3407), the system control returns to step S3406. When the portable terminal 103 is waiting for reception in the menu screen or the processing screen, the indication that the information is being processed is displayed. When the user A information is received (Yes at step S3407), the portable terminal 103 displays the received user A information as shown in FIG. 41, for example (step S3408).

The acceptance information is input in response to the user A displayed in FIG. 41 (step S3409). To be more specific, the user B selects Yes or No with a radio button 4101 in response to “Do you accept to share the taxi?”. When there are many user A, the user B selects Yes or No for each user A. When the user B selects Yes for any one user A, No is automatically selected for the other user A. This makes it possible to efficiently carry out the selection. It is also possible to prepare a profile for each user relating to the acceptance information of the user, by gathering information about selected user A and information about non-selected user A. It is possible to carry out the selection of a user A more efficiently, when this profile is used as a standard for selecting a user A at the time of making a request to share the taxi.

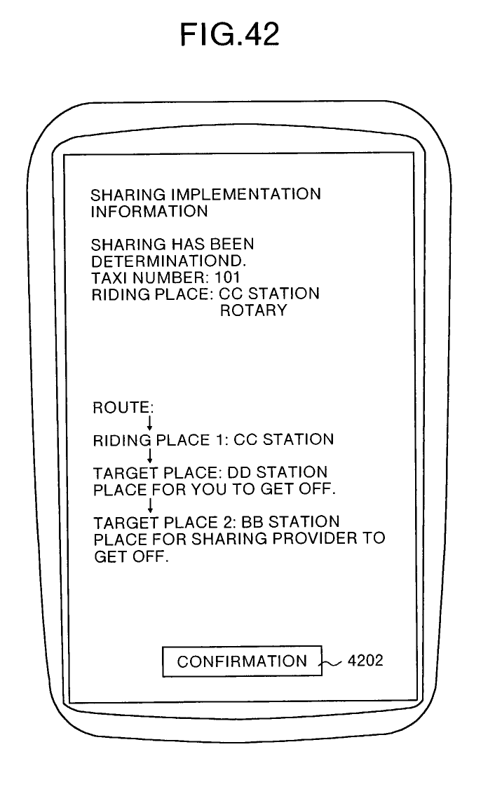

Next, the portable terminal 103 checks if a send button 4102 is pressed (step S3410). When the send button 4102 is not yet pressed (No at step S3410), the system control returns to step S3409, and the input process is carried out continuously. When the send button 4102 is pressed (Yes at step S3410), the portable terminal 103 transmits the sharing consent based on the input information (step S3411). Then, the portable terminal 103 decides whether sharing implementation information is received (step S3412). When the sharing implementation information is received (Yes at step S3412), the portable terminal 103 displays the received sharing implementation information as shown in FIG. 42 (step S3413). When a confirmation button 4202 is pressed in FIG. 42 (Yes at step S3414), the process ends.

According to the present embodiment, the sharing management server 101 determines the candidates based on the request from users B who want to ride the taxi 150 and the approval from a user A who is already onboard the taxi 150. The sharing management server 101 transmits information relating to the user B to the terminal 102. The sharing management server 101 also transmits the information relating to the user A to the portable termina 1103 who selects the user B based on the information of user B. The user B decides whether to consent to the sharing of the taxi based on the information relating to the user A. As a result, it is possible to find and know the person who is to share the taxi. With this arrangement, it is possible to implement the safe sharing of the taxi based on mutual agreement of the passengers.

According to the present embodiment, the taxi sharing management method has a computer-readable program that is created in advance. The program can be executed by a computer such as a personal computer and a workstation. The program is stored in a computer-readable recording medium such as a hard disk, a flexible disk, a CD-ROM, a MO, and a DVD. The computer reads the program from the recording medium and executes the program. The program may be a transmission medium that can be distributed through a network like the internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A taxi sharing management method for arranging a sharing of a taxi for first customers who want to take a taxi with a second customer who is already onboard the taxi, the taxi sharing management method comprising:
a sharing candidate determination step of determining one or a plurality of sharing candidates from among the first customers and inform to the second customer, based on information relating to the first customers that includes riding request information that has been input by each of the first customers, and information relating to a current position and information relating to a destination that have been input together with the riding request information or that have been extracted based on the riding request information, and information relating to a destination and sharing approval information that have been input by the second customer;
a sharing-accepted person selection step of selecting a sharing-accepted person from among the sharing candidates who have been determined at the sharing candidate determination step based on the information that has been input by the second customer;
a sharing consent information input step of receiving an input of sharing consent information relating to whether the sharing is consented or not, in response to the information relating to the second customer or that has been input together with the sharing approval information or the information relating to the sharing candidates or that has been extracted based on the sharing approval information; and
a sharing consent information transmission step of transmitting at least one of the sharing consent information and the information relating to a current position of the sharing-accepted person, to at least one of the second customer and a driver of the taxi which the second customer is already onboard, based on the information of the sharing consent that has been input at the sharing consent information input step.

2. The taxi sharing management method according to claim 1, wherein the sharing candidate determination step is a step of determining a sharing candidate separate from the determined sharing candidate, based on the information relating to the sharing-accepted person who has been selected at the sharing-accepted person selection step.

3. The taxi sharing management method according to claim 1, wherein the sharing candidate determination step is a step of determining a sharing candidate separate from the determined sharing candidate, based on the information on sharing consent that has been input-accepted at the sharing consent information input step.

4. The taxi sharing management method according to claim 1, wherein the riding request information includes guarantee information for guaranteeing the social standing of the first customer.

5. A taxi sharing management method for arranging a sharing of a taxi for first customers who want to take a taxi with a second customer who is already onboard the taxi, the taxi sharing management method comprising:
a riding request information reception step of receiving riding request information for requesting a ride on a taxi from the first customers;
a sharing approval information reception step of receiving information relating to a destination and sharing approval information for approving a sharing of a taxi from the second customer;
a sharing candidate determination step of determining one or a plurality of sharing candidates from among the first customers, based on the information relating to the first customers that includes the riding request information that has been received at the riding request information reception step, and information relating to a current position and information relating to a destination that have been received together with the riding request information or that have been extracted based on the riding request information, and the information relating to a destination and the sharing approval information that have been received at the sharing approval information reception step;
a first customer information transmission step of transmitting the information relating to the sharing candidates who have been determined at the sharing candidate determination step, to the second customer;
a sharing-accepted person information reception step of receiving information relating to a sharing-accepted person who has been selected by the second customer, from among the information relating to the sharing candidates that has been transmitted at the first customer information transmission step;
a second customer information transmission step of transmitting information relating to the second customer that has been received together with the sharing approval information or the information relating to the sharing candidates or that has been extracted based on the sharing approval information, to the sharing-accepted person, based on the information relating to the sharing-accepted person that has been received at the sharing-accepted person information reception step;
a sharing consent information reception step of receiving the sharing consent information relating to the sharing consent of the sharing-accepted person, in response to the information relating to the second customer that has been transmitted at the second customer information transmission step; and
a sharing consent information transmission step of transmitting at least one of the sharing consent information or the information relating to a current position of the sharing-accepted person, to at least one of the second customer and a driver of the taxi which the second customer is already onboard, based on the information of the sharing consent that has been received at the sharing consent information reception step.

6. The taxi sharing management method according to claim 5, wherein the sharing candidate determination step is a step of determining a sharing candidate separate from the determined sharing candidate, based on the information relating to the sharing-accepted person that has been received at the sharing-accepted person information reception step.

7. The taxi sharing management method according to claim 5, wherein the sharing candidate determination step is a step of determining a sharing candidate separate from the determined sharing candidate, based on the information on the sharing consent that has been received at the sharing consent information reception step.

8. The taxi sharing management method according to claim 5, wherein the riding request information includes guarantee information for guaranteeing the social standing of the first customer.

9. A taxi sharing management program for arranging a sharing of a taxi for first customers who want to take a taxi with a second customer who is already onboard the taxi, wherein the taxi sharing management program is for making a computer to execute:
a sharing candidate determination step of determining one or a plurality of sharing candidates from among the first customers and informs the second customer, based on information relating to the first customers that includes riding request information that has been input by each of the first customers, and information relating to a current position and information relating to a destination that have been input together with the riding request information or that have been extracted based on the riding request information, and information relating to a destination and sharing approval information that have been input by the second customer;
a sharing-accepted person selection step of selecting a sharing-accepted person from among the sharing candidates who have been determined at the sharing candidate determination step based on the information input by the second customer;
a sharing consent information input step of receiving a input of sharing consent information relating to whether the sharing is consented or not, in response to the information relating to the second customer that has been input together with the sharing approval information or the information relating to the sharing candidates or that has been extracted based on the sharing approval information; and
a sharing consent information transmission step of transmitting at least one of the sharing consent information and the information relating to a current position of the sharing-accepted person, to at least one of the second customer and a driver of the taxi which the second customer is already onboard, based on the information on the sharing consent that has been input at the sharing consent information input step.

10. A taxi sharing management program for arranging a sharing of a taxi for first customers who want to take a taxi with a second customer who is already onboard the taxi, wherein the taxi sharing management program is for making a computer to execute:
a riding request information reception step of receiving riding request information from the first customers;
a sharing approval information reception step of receiving information relating to a destination and sharing approval information from the second customer;
a sharing candidate determination step of determining one or a plurality of sharing candidates from among the first customers, based on the information relating to the first customers that includes the riding request information that has been received at the riding request information reception step, and information relating to a current position and information relating to a destination that have been received together with the riding request information or that have been extracted based on the riding request information, and the information relating to a destination and the sharing approval information that have been received at the sharing approval information reception step;
a first customer information transmission step of transmitting the information relating to the sharing candidates who have been determined at the sharing candidate determination step, to the second customer;
a sharing-accepted person information reception step of receiving information relating to a sharing-accepted person who has been selected by the second customer, from among the information relating to the sharing candidates that has been transmitted at the first customer information transmission step;
a second customer information transmission step of transmitting information relating to the second customer that has been received together with the sharing approval information or the information relating to the sharing candidates or that has been extracted based on the sharing approval information, to the sharing-accepted person, based on the information relating to the sharing-accepted person that has been received at the sharing-accepted person information reception step;
a sharing consent information reception step of receiving the sharing consent information relating to the sharing consent of the sharing-accepted person, in response to the information relating to the second customer that has been transmitted at the second customer information transmission step; and
a sharing consent information transmission step of transmitting at least one of the sharing consent information and the information relating to a current position of the sharing-accepted person, to at least one of the second customer and a driver of the taxi which the second customer is already onboard, based on the information on the sharing consent that has been received at the sharing consent information reception step.

11. A computer-readable recording medium that is recorded with a taxi sharing management program for arranging a sharing of a taxi for first customers who want to take a taxi with a second customer who is already onboard the taxi, wherein the taxi sharing management program is for making a computer to execute:
a sharing candidate determination step of determining one or a plurality of sharing candidates from among the first customers and informs the second customer, based on information relating to the first customers that includes riding request information that has been input by each of the first customers, and information relating to a current position and information relating to a destination that have been input together with the riding request information or that have been extracted based on the riding request information, and information relating to a destination and sharing approval information that have been input by the second customer;
a sharing-accepted person selection step of selecting a sharing-accepted person from among the sharing candidates who have been determined at the sharing candidate determination step based on the information input by the second customer;
a sharing consent information input step of receiving an input of sharing consent information relating to whether the sharing is consented or not, in response to the information relating to the second customer that has been input together with the sharing approval information or the information relating to the sharing candidates or that has been extracted based on the sharing approval information; and
a sharing consent information transmission step of transmitting at least one of the sharing consent information and the information relating to a current position of the sharing-accepted person, to at least one of the second customer and a driver of the taxi which the second customer is already onboard, based on the information of the sharing consent that has been input at the sharing consent information input step.

12. A computer-readable recording medium that is recorded with a taxi sharing management program for arranging a sharing of a taxi for first customers who want to take a taxi with a second customer who is already onboard the taxi, wherein the taxi sharing management program is for making a computer to execute:
a riding request information reception step of receiving riding request information from the first customers;
a sharing approval information reception step of receiving information relating to a destination and sharing approval information from the second customer;
a sharing candidate determination step of determining one or a plurality of sharing candidates from among the first customers, based on the information relating to the first customers that includes the riding request information that has been received at the riding request information reception step, and information relating to a current position and information relating to a destination that have been received together with the riding request information or that have been extracted based on the riding request information, and the information relating to a destination and the sharing approval information that have been received at the sharing approval information reception step;
a first customer information transmission step of transmitting the information relating to the sharing candidates who have been determined at the sharing candidate determination step, to the second customer;
a sharing-accepted person information reception step of receiving information relating to a sharing-accepted person who has been selected by the second customer, from among the information relating to the sharing candidates that has been transmitted at the first customer information transmission step;
a second customer information transmission step of transmitting information relating to the second customer that has been received together with the sharing approval information or the information relating to the sharing candidates or that has been extracted based on the sharing approval information, to the sharing-accepted person, based on the information relating to the sharing-accepted person that has been received at the sharing-accepted person information reception step;
a sharing consent information reception step of receiving sharing consent information relating to the sharing consent of the sharing-accepted person, in response to the information relating to the second customer that has been transmitted at the second customer information transmission step; and
a sharing consent information transmission step of transmitting at least one of the sharing consent information from the sharing-accepted person and the information relating to a current position of the sharing-accepted person, to at least one of the second customer and a driver of the taxi which the second customer is already onboard, based on the information relating to the sharing consent that has been received at the sharing consent information reception step.

13. A taxi sharing management apparatus that arranges a sharing of a taxi for first customers who want to take a taxi with a second customer who is already onboard the taxi, the taxi sharing management apparatus comprising:
a riding request information reception unit that receives riding request information from information terminal devices of the first customers;
a sharing approval information reception unit that receives information relating to a destination and sharing approval information from an information device of the second customer;
a sharing candidate determination unit that determines one or a plurality of sharing candidates from among the first customers, based on the information relating to the first customers that includes the riding request information that has been received by the riding request information reception unit, and information relating to a current position and information relating to a destination that have been received together with the riding request information or that have been extracted based on the riding request information, and the information relating to a destination and the sharing approval information that have been received by the sharing approval information reception unit;
a first customer information transmission unit that transmits the information relating to the sharing candidates who have been determined by the sharing candidate determination unit, to the information terminal device of the second customer;
a sharing-accepted person information reception unit that receives information relating to a sharing-accepted person who has been selected by the second customer, from among the information relating to the sharing candidates that has been transmitted by the first customer information transmission unit;
a second customer information transmission unit that transmits information relating to the second customer that has been received together with the sharing approval information or the information relating to the sharing candidates or that has been extracted based on the sharing approval information, to the information terminal device of the sharing-accepted person, based on the information relating to the sharing-accepted person that has been received by the sharing-accepted person information reception unit;
a sharing consent information reception unit that receives sharing information relating to the sharing consent of the sharing-accepted person, in response to the information relating to the second customer that has been transmitted by the second customer information transmission unit; and
a sharing consent information transmission unit that transmits at least one of the sharing consent information from the sharing-accepted person and the information relating to a current position of the sharing-accepted person, to at least one of the information terminal device of the second customer and the information terminal device of a driver of the taxi which the second customer is already onboard, based on the information relating to the sharing consent that has been received by the sharing consent information reception unit.

14. The taxi sharing management apparatus according to claim 13, wherein the information terminal devices of the first customers are portable information processing devices owned by the first customers.

15. The taxi sharing management apparatus according to claim 13, wherein the information terminal device of the second customer is provided in the taxi that the second customer is onboard.

16. The taxi sharing management apparatus according to claim 13, wherein the information terminal device of the second customer is a portable information processing device owned by the second customer.

17. A taxi sharing approval apparatus that enables persons who want to take a taxi to share the taxi, the taxi sharing approval apparatus comprising:
an input unit that inputs information relating to a destination and sharing approval information for approving a sharing of a taxi;
a sharing approval information transmission unit that transmits the information relating to a destination and the sharing approval information that have been input by the input unit, to a predetermined server;
a riding requester information reception unit that receives the information relating to one or a plurality of riding requesters, in response to the sharing approval information that has been transmitted by the sharing approval information transmission unit from the server;
a display control unit that controls a display screen to display the information relating to the riding requesters that has been received by the riding requester information reception unit;
a sharing-accepted person selection unit that selects a sharing-accepted person from the information relating to the riding requesters that is displayed on the display screen;
a sharing-accepted person information transmission unit that transmits the information relating to the sharing-accepted person selected by the sharing-accepted person selection unit, to the server; and
a sharing consent information reception unit that receives from the server at least one of sharing consent information as the sharing-accepted person and information relating to a current position of the sharing-accepted person.

18. The taxi sharing approval apparatus according to claim 17, wherein the display control unit controls the display screen to display a map, display a route to the destination on the map, and mark at least one of the current position and the destination of the riding requester on the map.

19. The taxi sharing approval apparatus according to claim 18 further comprising:
a riding requester selection unit that selects the riding requester by indicating at least one of the marked current positions and destinations of the riding requesters, wherein the display control unit controls the display screen to display information relating to a riding requester who has been selected by the riding requester selection unit.

20. A taxi riding request apparatus that is used by a person who wants to take a taxi, the taxi riding request apparatus comprising:
a riding request information input unit that inputs riding request information for requesting a ride on a taxi;
a riding request information transmission unit that transmits the riding request information that has been input by the riding request information input unit, to a predetermined server;
a reception unit that receives from the server, information relating to a person who is already onboard a taxi to share the taxi, in response to the riding request information that has been transmitted by the riding request information transmission unit;
a display control unit that controls a display screen to display the information relating to the other person to share the taxi that has been received by the reception unit;
a sharing consent information input unit that inputs sharing consent information relating to whether the sharing of the taxi is to be consented or not, in response to the information relating to the other person to share the taxi that is displayed on the display screen; and
a sharing consent information transmission unit that transmits the sharing consent information that has been input by the sharing consent information input unit, to the server.
